(19) United States
(12) Patent Application Publication
(10) Pub. No.: US 2025/0226857 A1
(43) Pub. Date: Jul. 10, 2025

(54) SOUNDING AND CSI FEEDBACK FOR COORDINATED BEAMFORMING

(71) Applicant: QUALCOMM Incorporated, San Diego, CA (US)

(72) Inventors: Jialing Li CHEN, San Diego, CA (US); Sameer VERMANI, San Diego, CA (US); Bin TIAN, San Diego, CA (US)

(21) Appl. No.: 19/009,559

(22) Filed: Jan. 3, 2025

Related U.S. Application Data
(60) Provisional application No. 63/563,563, filed on Mar. 11, 2024.
(60) Provisional application No. 63/563,568, filed on Mar. 11, 2024.
(60) Provisional application No. 63/619,725, filed on Jan. 10, 2024.

(51) Int. Cl. H04B 7/0417; H04B 7/0452

(52) U.S. Cl. CPC H04B 7/0417; H04B 7/0452

(57) ABSTRACT

Certain aspects of the present disclosure provides a method for wireless communication performable at a first wireless station, generally including obtaining one or more packets from a first wireless node and at least one second wireless node, wherein the wireless station and first wireless node are associated with a first basic service set (BSS) and the second wireless node is associated with a second BSS, generating channel state information (CSI) feedback, based on the one or more packets, for a first channel between the wireless station and the first wireless node and for a second channel between the wireless station and the second wireless node, and providing the CSI feedback to at least the first wireless node.

### CROSS-REFERENCE TO RELATED APPLICATIONS

This application claims the benefit of and priority to U.S. Provisional Application No. 63/563,568, filed Mar. 11, 2024; U.S. Provisional Application No. 63/563,563, filed Mar. 11, 2024; and U.S. Provisional Application No. 63/619,725, filed Jan. 10, 2024, each of which are assigned to the assignee hereof and hereby expressly incorporated by reference in its entirety as if fully set forth below and for all applicable purposes.

### TECHNICAL FIELD

This disclosure relates generally to wireless communication, and more specifically, to coordinated beamforming (CoBF).

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

### SUMMARY

One aspect provides a method for wireless communications at a first wireless node. The method includes outputting at least one packet to solicit channel state information (CSI) feedback from at least a first wireless station and a second wireless station, wherein the first wireless station, the second wireless station, and the first wireless node are associated with a first basic service set (BSS); obtaining CSI feedback after outputting the at least one packet, wherein the CSI feedback comprises first CSI feedback for a first channel between the first wireless station and a second wireless node and second CSI feedback for a second channel between the second wireless station and the second wireless node, wherein the second wireless node is associated with a second BSS; compressing the CSI feedback; and providing the compressed CSI feedback to the second wireless node.

Another aspect provides a method for wireless communications at a first wireless node. The method includes outputting at least one packet to solicit CSI feedback from at least a first wireless station and a second wireless station, wherein the first wireless station, the second wireless station, and the first wireless node are associated with a first BSS; obtaining CSI feedback after outputting the at least one packet, wherein the CSI feedback comprises first CSI feedback for a first channel between the first wireless station and a second wireless node and second CSI feedback for a second channel between the second wireless station and the second wireless node, wherein the second wireless node is associated with a second BSS; compressing the CSI feedback; and providing the compressed CSI feedback to the second wireless node.

One aspect provides a method for wireless communications at a second wireless node. The method includes outputting at least one packet to solicit CSI feedback from at least a first wireless station and a second wireless station, wherein the first wireless station, the second wireless station, and a first wireless node are associated with a first BSS and the second wireless node is associated with a second BSS; obtaining compressed CSI feedback from the wireless node; and using the compressed CSI feedback to form nulls to at least one of the first wireless station or the second wireless station.

Another aspect provides a method for wireless communications at a second wireless node. The method includes outputting at least one packet to solicit CSI feedback from at least a first wireless station and a second wireless station, wherein the first wireless station, the second wireless station, and a first wireless node are associated with a first BSS and the second wireless node is associated with a second BSS; obtaining compressed CSI feedback from the wireless node; and using the compressed CSI feedback to form nulls to at least one of the first wireless station or the second wireless station.

One aspect provides a method for wireless communications at a first wireless node. The method includes outputting at least one packet to solicit CSI feedback from at least a first wireless station, wherein the first wireless station and the first wireless node are associated with a first BSS; providing information that allows the first wireless station to differentiate between a first channel between the first wireless node and the first wireless station and a second channel between a second wireless node and the first wireless station, wherein the second wireless node is associated with a second BSS; and obtaining CSI feedback after outputting the at least one packet and after providing the information, wherein the CSI feedback comprises first CSI feedback for the first channel and second CSI feedback for the second channel.

Another aspect provides a method for wireless communications at a first wireless node. The method includes outputting at least one packet to solicit CSI feedback from at least a first wireless station, wherein the first wireless station and the first wireless node are associated with a first BSS; providing information that allows the first wireless station to differentiate between a first channel between the first wireless node and the first wireless station and a second channel between a second wireless node and the first wireless station, wherein the second wireless node is associated with a second BSS; and obtaining CSI feedback after outputting the at least one packet and after providing the information, wherein the CSI feedback comprises first CSI feedback for the first channel and second CSI feedback for the second channel.

One aspect provides a method for wireless communications at a first wireless station. The method includes obtaining one or more packets from a first wireless node and at least one second wireless node, wherein the first wireless station and the first wireless node are associated with a first BSS and the second wireless node is associated with a second BSS; obtaining information from the first wireless station that allows the first wireless station to differentiate between a first channel between the first wireless node and the first wireless station and a second channel between a second wireless node and the first wireless station, wherein the second wireless node is associated with a second BSS; generating CSI feedback, based on the one or more packets, for the first channel and for the second channel; and providing the CSI feedback to at least the first wireless node.

Another aspect provides a method for wireless communications at a first wireless station. The method includes obtaining one or more packets from a first wireless node and at least one second wireless node, wherein the first wireless station and the first wireless node are associated with a first BSS and the second wireless node is associated with a second BSS; obtaining information from the first wireless station that allows the first wireless station to differentiate between a first channel between the first wireless node and the first wireless station and a second channel between a second wireless node and the first wireless station, wherein the second wireless node is associated with a second BSS; generating CSI feedback, based on the one or more packets, for the first channel and for the second channel; and providing the CSI feedback to at least the first wireless node.

One aspect provides a method for wireless communications at a second wireless node. The method includes obtaining information from a first wireless node; and outputting at least one packet to solicit CSI feedback from at least a first wireless station, wherein the first wireless station and the first wireless node are associated with a first BSS and the second wireless node is associated with a second BSS, and the at least one packet is output using the information obtained from the first wireless node.

Another aspect provides a method for wireless communications at a second wireless node. The method includes obtaining information from a first wireless node; and outputting at least one packet to solicit CSI feedback from at least a first wireless station, wherein the first wireless station and the first wireless node are associated with a first BSS and the second wireless node is associated with a second BSS, and the at least one packet is output using the information obtained from the first wireless node.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point (AP) and one or more wireless stations (STAs).

FIG. 3 shows a hierarchical format of an example physical layer PDU (PPDU) usable for communications between a wireless AP and one or more wireless STAs.

FIGS. 4 and 5 show pictorial diagrams of example wireless communication networks, in which coordinated beamforming (CoBF) may be utilized.

FIGS. 6A, 6B, and 7 show example timing diagrams for channel state information (CSI) feedback for CoBF.

FIGS. 8, 9, and 10 show example diagrams of sounding and CSI feedback for CoBF, in accordance with aspects of the present disclosure.

FIG. 11 shows an example diagram of sounding and CSI feedback for CoBF, in accordance with aspects of the present disclosure.

FIGS. 12 and 13 show example timing diagrams for channel state information (CSI) feedback for CoBF.

FIG. 14 shows a flowchart illustrating example process performable by a wireless device or wireless node.

FIG. 15 shows another flowchart illustrating example process performable by a wireless device or wireless node.

FIG. 16 shows another flowchart illustrating example process performable by a wireless device or wireless node.

FIG. 17 shows another flowchart illustrating example process performable by a wireless device or wireless node.

FIG. 18 shows another flowchart illustrating example process performable by a wireless device or wireless node.

FIG. 19 shows another flowchart illustrating example process performable by a wireless device or wireless node.

FIG. 20 shows another flowchart illustrating example process performable by a wireless device or wireless node.

FIG. 21 shows a block diagram of an example wireless communication device.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3^{rd} Generation Partnership Project (3GPP), among others. The described examples can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO. The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IoT) network.

In order to address the issue of increasing bandwidth requirements that are demanded for wireless communication systems, different schemes are being developed to allow multiple user terminals to communicate with a single access point (AP) or multiple APs by sharing the channel resources while achieving high data throughputs. Multiple Input Multiple Output (MIMO) technology represents one such approach that has recently emerged as a popular technique for the next generation communication systems.

A MIMO system employs multiple (N_{T}) transmit antennas and multiple (NR) receive antennas for data transmission. A MIMO channel formed by the N_{T} transmit and N_{R} receive antennas may be decomposed into N_{S} independent channels, which are also referred to as spatial channels, where N_{S}≤min{N_{T}, N_{R}}. Each of the N_{S} independent channels corresponds to a dimension. The MIMO system can provide improved performance (such as higher throughput and greater reliability) if the additional dimensionalities created by the multiple transmit and receive antennas are utilized.

In wireless networks with multiple APs and multiple user stations (STAs), concurrent transmissions may occur on multiple channels toward different STAs, both in uplink and downlink directions. Many challenges are present in such systems. For example, the AP may transmit signals using different standards. A receiver STA may be able to detect a transmission mode of the signal based on information included in a preamble of the transmission packet.

A downlink multi-user MIMO (MU-MIMO) system based on Spatial Division Multiple Access (SDMA) transmission can simultaneously serve a plurality of spatially separated STAs by applying beamforming at the AP's antenna array. Complex transmit precoding weights can be calculated by the AP based on channel state information (CSI) received from each of the supported STAs.

In a distributed MU-MIMO system, multiple APs may simultaneously serve a plurality of spatially separated STAs by coordinating beamforming by the antennas of the multiple APs. For example, in systems utilizing such coordinated beamforming (CoBF), multiple APs may coordinate transmissions to each STA in an effort to mitigate interference to each other's STAs.

In CoBF, an AP of one basic service set (BSS) may obtain channel state information (CSI) from non-AP STAs of an overlapping BSS (OBSS) in order to mitigate interference (e.g., by forming nulls) to the STA(s). This may involve cross-BSS sounding and CSI feedback from non-AP STA(s) to OBSS AP(s). Each AP may also obtain CSI from its own BSS non-AP STA(s) for forming beams to the STA(s).

Various aspects of the present disclosure provide various mechanisms for performing sounding, CSI processing, and feedback for CoBF. According to certain aspects, processing performed at the non-AP STAs when generating CSI-FB may help optimize CSI processing at the APs.

Particular aspects of the subject matter described in this disclosure can be implemented to realize one or more of the following potential advantages. In some examples, CSI feedback and corresponding processing proposed herein may help enhance CoBF, which may help improve interference mitigation, spectral efficiency, and overall system network performance.

### Example Wireless Communication Network

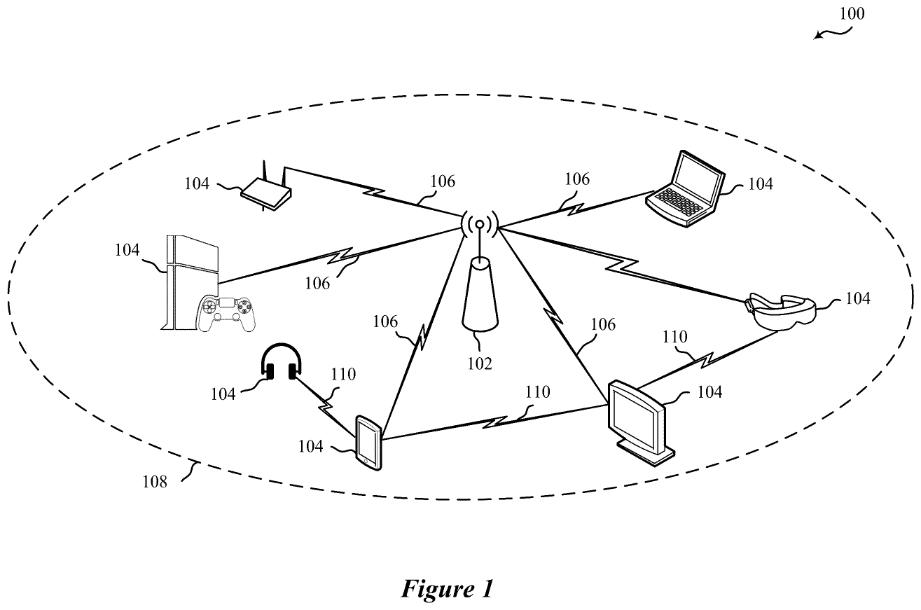

FIG. 1 shows a pictorial diagram of an example wireless communication network 100. The wireless communication network 100 includes various wireless nodes (such as AP STAs and non-AP STAs). According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bd, 802.11be, 802.11bf, and 802.11bn). In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core.

The wireless communication network 100 may include numerous wireless communication devices including at least one wireless access point (AP) 102 and any number of wireless stations (STAs) 104. While only one AP 102 is shown in FIG. 1, the wireless communication network 100 can include multiple APs 102. The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some cases, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some cases, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network (e.g., WLAN) 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

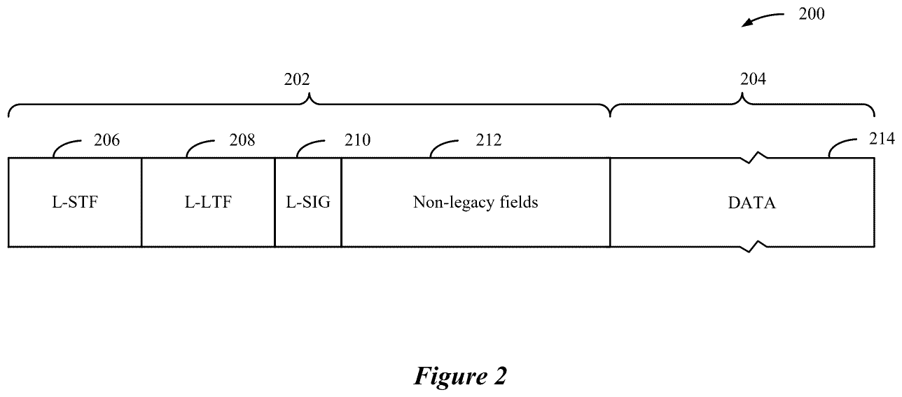

FIG. 2 shows an example protocol data unit (PDU) 200 usable for wireless communication between a wireless AP 102 and one or more wireless STAs 104. For example, the PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device to perform coarse timing and frequency tracking and automatic gain control (AGC). The L-LTF 208 generally enables a receiving device to perform fine timing and frequency tracking and also to perform an initial estimate of the wireless channel. The L-SIG 210 generally enables a receiving device to determine (for example, obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

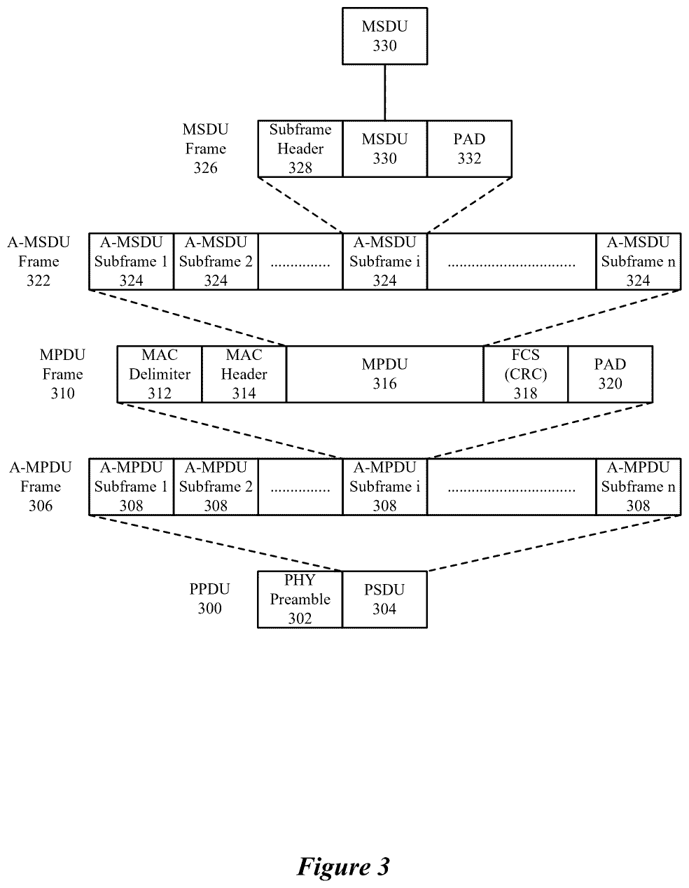

FIG. 3 shows a hierarchical format of an example PPDU usable for communications between a wireless AP 102 and one or more wireless STAs 104. As described, each PPDU 300 includes a PHY preamble 302 and a PSDU 304. Each PSDU 304 may represent (or “carry”) one or more MAC protocol data units (MPDUs) 316. For example, each PSDU 304 may carry an aggregated MPDU (A-MPDU) 306 that includes an aggregation of multiple A-MPDU subframes 308. Each A-MPDU subframe 308 may include an MPDU frame 310 that includes a MAC delimiter 312 and a MAC header 314 prior to the accompanying MPDU 316, which includes the data portion (“payload” or “frame body”) of the MPDU frame 310. Each MPDU frame 310 also may include a frame check sequence (FCS) field 318 for error detection (for example, the FCS field may include a cyclic redundancy check (CRC)) and padding bits 320. The MPDU 316 may carry one or more MAC service data units (MSDUs) 330. For example, the MPDU 316 may carry an aggregated MSDU (A-MSDU) 322 including multiple A-MSDU subframes 324. Each A-MSDU subframe 324 contains a corresponding MSDU 330 preceded by a subframe header 328 and in some cases followed by padding bits 332.

Referring back to the MPDU frame 310, the MAC delimiter 312 may serve as a marker of the start of the associated MPDU 316 and indicate the length of the associated MPDU 316. The MAC header 314 may include multiple fields containing information that defines or indicates characteristics or attributes of data encapsulated within the frame body 316. The MAC header 314 includes a duration field indicating a duration extending from the end of the PPDU until at least the end of an acknowledgment (ACK) or Block ACK (BA) of the PPDU that is to be transmitted by the receiving wireless communication device. The use of the duration field serves to reserve the wireless medium for the indicated duration, and enables the receiving device to establish its network allocation vector (NAV). The MAC header 314 also includes one or more fields indicating addresses for the data encapsulated within the frame body 316. For example, the MAC header 314 may include a combination of a source address, a transmitter address, a receiver address or a destination address. The MAC header 314 may further include a frame control field containing control information. The frame control field may specify a frame type, for example, a data frame, a control frame, or a management frame.

### Example Coordinated Communications

In downlink (DL) multi-user multiple-input-multiple-output (MU-MIMO), multiple stations may belong to one basic service set (BSS) transmitting in the DL. Other BSSs (OBSSs) within “hearing” range may defer (not transmit on the medium) in response to detecting an on-going transmission. Different BSSs in hearing range of each other may use time-divisional multiplexing (TDM) to transmit in the DL. In coordinated UL MU-MIMO, multiple BSSs carry out simultaneous UL transmissions. Un-used receive spatial dimensions at the AP may be used to null the interference from the other BSS (OBSS) transmissions. This enables a greater degree of spatial multiplexing when there are un-used spatial dimension within the BSS. In other words, the un-used spatial dimensions may allow for concurrent OBSS transmissions in DL.

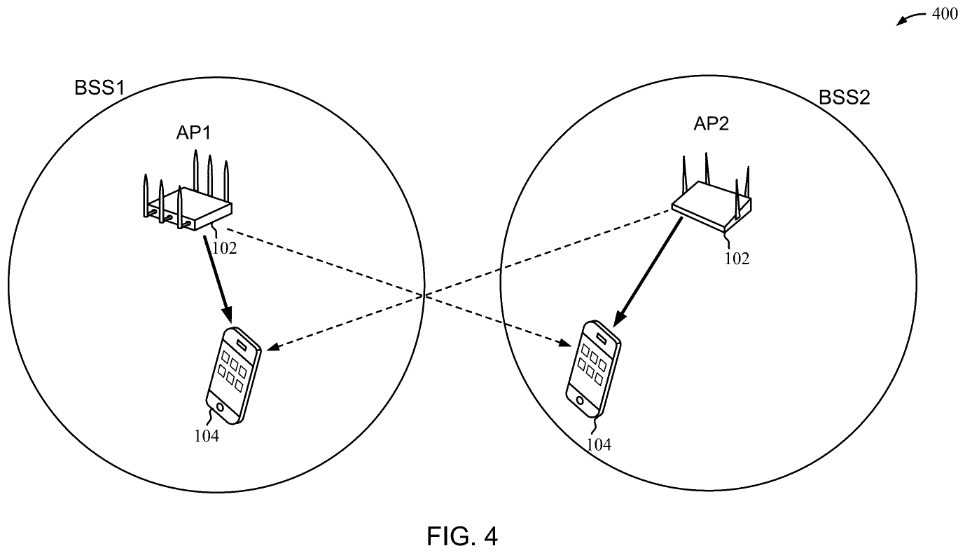

FIG. 4 illustrates a communication system 400 using coordinated DL MU-MIMO, in accordance with certain aspects of the present disclosure. As illustrated, the signal from each AP 102 is transmitted to only stations within their respective BSSs, as shown by the solid lines representing data transmissions from the AP the STAs 104 that are associated with the AP. The data transmissions from the APs cause interference to the other OBSS stations, as illustrated by the dotted lines. Un-used dimensions at the AP may be used to get rid of (e.g., null out) interference from OBSS APs.

In uplink (UL) multi-user multiple-input-multiple-output (MU-MIMO), multiple stations belonging to one BSS may transmit in the UL. Other BSSs within range may defer to an on-going transmission. Different BSSs in range of each other may use time-divisional multiplexing (TDM) to transmit in the UL. In coordinated UL MU-MIMO, multiple BSSs carry out simultaneous UL transmissions. As with DL MU-MIMO, un-used receive spatial dimensions at an AP may be used to null the interference from the other BSS (OBSS) transmissions, enabling a greater degree of spatial multiplexing and allowing for concurrent OBSS transmissions.

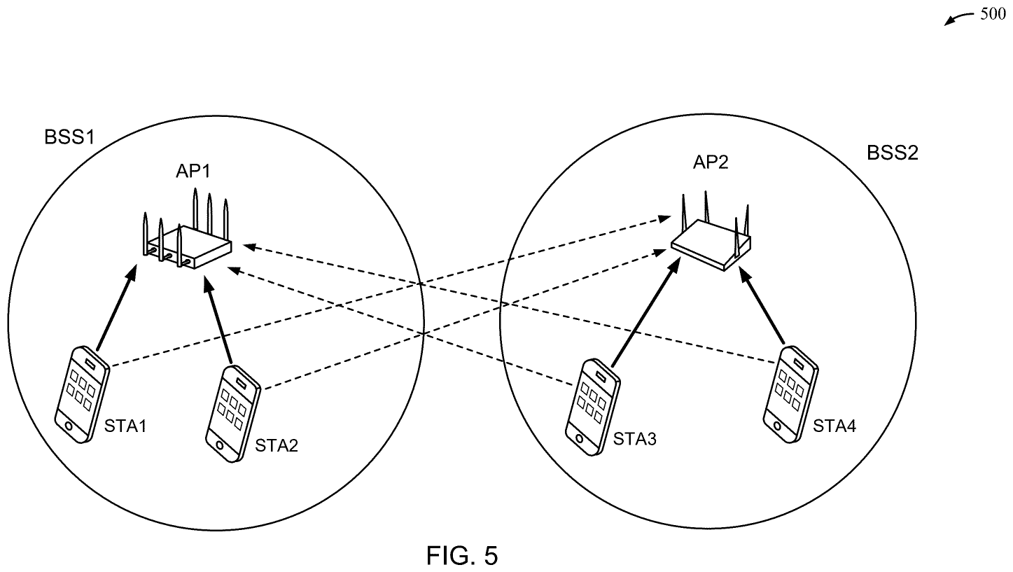

FIG. 5 illustrates an example system 500 that may utilize coordinated UL MU-MIMO. As illustrated, the signal from each STA 104 may be transmitted to only one AP 102 within their respective BSSs, as shown by the solid lines representing data transmissions to the AP the STAs are associated with. The data transmissions from the STAs cause interference to the other OBSS APs, as illustrated by the dotted lines. Un-used spatial dimensions at each AP may be used to mitigate (e.g., reduce or null out) interference from OBSS STAs.

Coordinated beamforming (CoBF) may include one or more protocols for coordinating (e.g., synchronizing) transmissions from different entities, for example, to form nulls to control interference to STAs of other OBSS, while transmitting to own (BSS) STAs.

### Example Coordinated Beamforming

As previously described, in CoBF, multiple APs may coordinate to suppress OBSS interference in the spatial domain. As such, CoBF typically provides gains in an opportunistic manner, for example, when in-BSS transmissions are not fully utilizing that BSS AP's spatial dimensions.

There are various types of CoBF, such as symmetric CoBF with synchronized or asynchronized transmission and asymmetric CoBF with synchronized or asynchronized transmission. With symmetric CoBF, all APs may participate in coordinated beamforming and to suppress their obsess interference to other victim STAs within other BSSs. With asymmetric CoBF, one device (or set of devices) may have higher or lower priority than other devices and/or may lack the capability to suppress OBSS interference.

In general, there can be multiple APs participating in CoBF. To facilitate understanding, however, example techniques will be described herein with reference to a CoBF scenario involving 2 APs. The techniques described herein may be extended to systems involving any number of APs.

The techniques described herein involve various processing for sounding and CSI feedback in CoBF. The techniques described herein may be applied to symmetric CoBF and asymmetric CoBF. As described above, in CoBF, an AP may obtain CSI from OBSS non-AP STA(s) to form nulls to the STA(s). This may involve cross-BSS sounding and CSI feedback from non-AP STA(s) to OBSS AP(s). Each AP may also obtain CSI from its own serving non-AP STA(s) to form beams to those STA(s)

In asymmetric CoBF, sounding may involve transmission of just one packet, such as a null data packet (NDP), from a secondary AP to primary recipient. In symmetric CoBF, each AP may send out an NDP to sound the intended and interfering channels. In this context, sounding generally refers to a mechanism used to gather information about the characteristics of a communication channel, in order to optimize transmission parameters to improve the overall performance of CoBF. Sounding typically involves sending specific probe frames or signals and then analyzing the responses that provide CSI feedback, to understand the channel behavior.

There are various options for sounding, for example, involving sending out NDPs to solicit CSI feedback for intended and interfering channels. In this context, an intended channel may refer to a channel between an AP and a non-AP STA served by that AP (e.g., in a same BSS), while an interfering channel may refer to a channel between an OBSS AP and a non-AP STA.

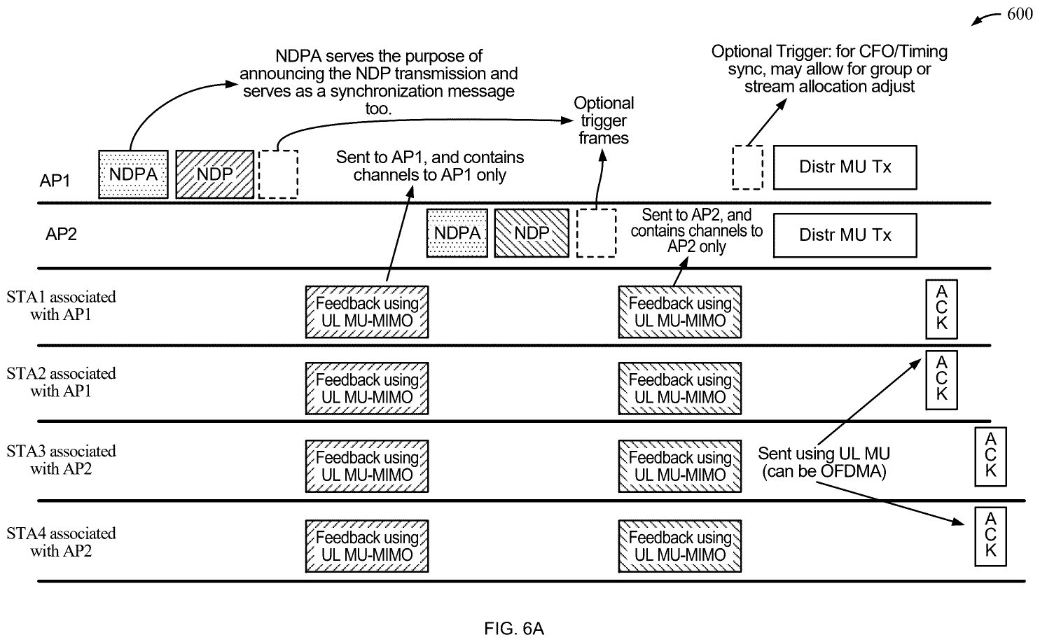

According to a first option, as illustrated in diagram 600 of FIG. 6A, each AP sends one NDP to intended and victim STAs, in a sequential manner.

In such cases, the BSS color of the AP may be included in the NDP so each STAs knows from which AP the NDP (and estimated channel) comes from. In the illustrated example, two APs (e.g., AP1 and AP2 of FIG. 5) send sequential NDPs. Based on the NDP sent from the j-th AP, each STA (e.g., the i-th STA) estimates the channel, Hᵢⱼ, channel matrix from j-th AP to the i-th STA.

As illustrated in diagram 650 of FIG. 6B, in some cases, non-AP STAs may not send CSI feedback until after all NDPs are sent and all channels are estimated.

In the illustrated example, AP1 send an NDPA and NDP, then AP2 sends an NDPA and NDP. AP1 sends a Trigger frame (TF) and at the same time AP2 may send an optional TF, triggering the STAs to send CSI feedback to both APs. To generate the CSI feedback, the non-AP STAs could use the enhanced CSI processing and small V feedback techniques described herein. The non-AP STAs could also use the large V feedback of the composite channels, provided the phase and automatic gain control (AGC) at each non-AP STAs use the same phase and AGC setting when processing all of NDP packets.

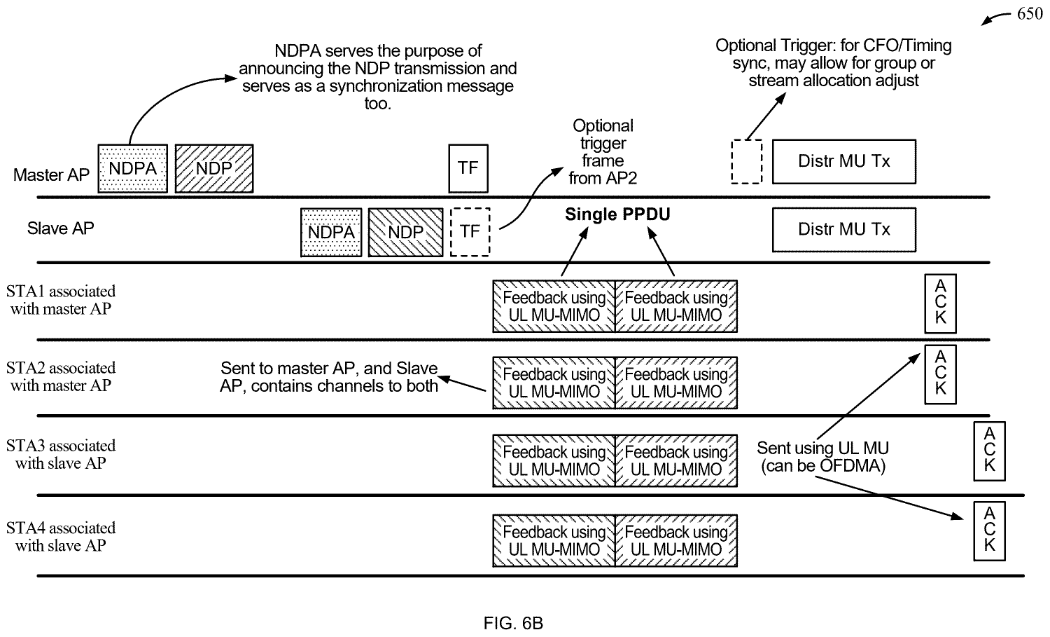

According to a second option, as illustrated in diagram 700 of FIG. 7, APs participating in CoBF may collaboratively send out a (e.g., joint) NDP to all serving STAs. The NDP may be considered a joint NDP, even though it is sent from two different APs.

In this context, a joint NDP may be one PPDU sent from both APs, with identical information (transmitted by each AP) in all fields except in a long training field (e.g., a UHR-LTF) field. In the LTF, each AP may send different streams, and the streams sent from different APs may use mutually different indices. In this manner, all APs may share a joint LTF, where the first subset of streams are sent from a 1st AP, and the second subset of streams are sent from a 2nd AP, so that the estimated channel is a composite channel where the first subset of streams are from the 1st AP and the second subset of streams are from the 2nd AP.

The joint NDP may use a group BSS color for the group of CoBF APs. The group BSS color may be sent in a prior packet, such as an NDP announcement (NDPA) frame from one of the APs (e.g., a sharing AP), before the joint NDP.

According to certain aspects of the present disclosure, to aid in CSI processing by a non-AP STA, a joint NDP may indicate which part of composite channel comes from which AP. For example, the joint NDP (or some other signaling mechanism) may signal the numbers of transmit (Tx) antennas or streams from different APs, i.e., [N_tx_1, N_tx_2, . . . ] or [N_ss_1, N_ss_2, . . . ] and the list of CoBF BSS IDs in NDPA, so that STAs know which part of composite channel comes from intended AP and which part comes from interfering AP(s). Alternatively, the joint NDP (e.g., or some other signaling mechanism) may signal the starting stream indices for different APs and the list of CoBF BSS IDs in NDPA. If the numbers of Tx antennas or streams from different APs or the start stream indices for different APs are signaled, they may be in a prior packet, e.g., NDPA, or in the joint NDP packet (e.g., in U-SIG or the common field of the UHR-SIG).

With joint sounding, each STA (the i-th STA) may estimate the composite channel matrix at from Nₐₚ APs as Hᵢ=[Hᵢ₁ Hᵢ₂ . . . H_{iN}_{ₐₚ}], where each Hij represents a channel matrix for a channel between STAi and APj. Joint NDP may have less overhead, and may help with enhanced coordinated spatial reuse (CSR) and/or joint transmission (JT) to a single or multiple STAs.

Aspects of the present disclosure also provide various options for sending CSI feedback, including cross-BSS CSI feedback (CSI-FB). In some cases, a backhaul (e.g., a light backhaul) between APs may be used for CSI exchange. In such cases, all STAs may send CSI feedbacks to their own APs and the APs may share with each other (e.g., exchanging CSI feedback) over the backhaul. In this case, UL transmissions (e.g., of CSI-FB) to own APs may be done in parallel, for example, if using coordinated UL MU-MIMO or coordinated UL OFDMA.

In some cases, if there is no backhaul, it may be assumed that coordinated UL MU-MIMO is used. In such cases, STAs may transmit to their own APs in parallel, then the STAs may transmit to OBSS in APs in parallel. In other cases, coordinated UL MU-MIMO may not be assumed, though this may mean both APs do not receive simultaneously and, hence, may have additional latency for each STA to feedback to all the APs one at a time.

In some cases, coordinated UL MU-MIMO may involve CoBF, with un-utilized spatial dimensions of the AP used to perform receive (Rx) nulling of OBSS UL transmissions.

Aspects of the present disclosure provide various options that may be applied in both point-to-point channel CSI processing and feedback and composite channel CSI processing and feedback.

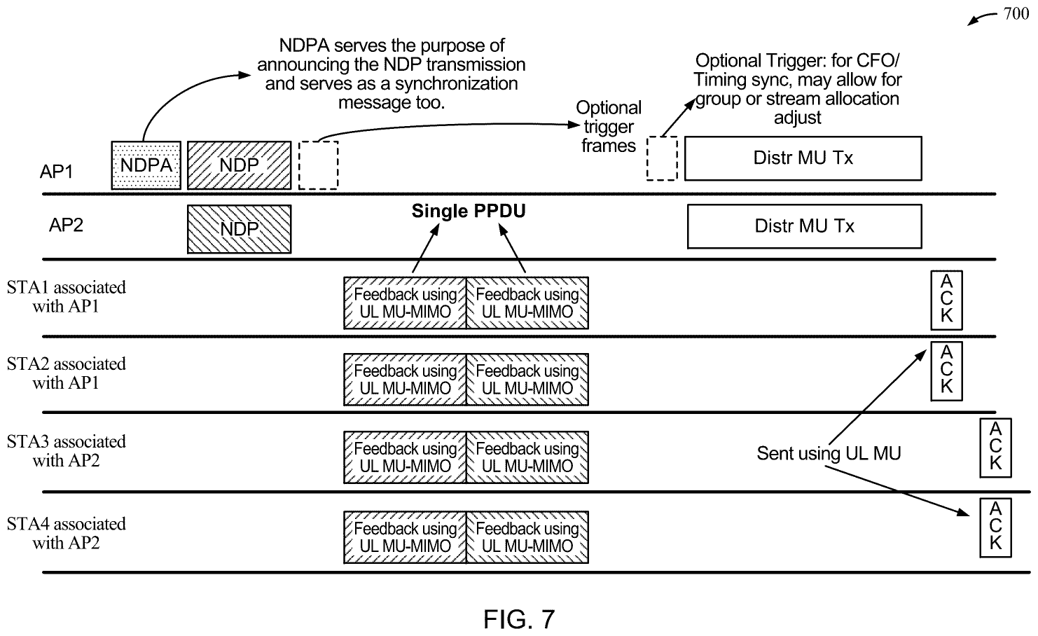

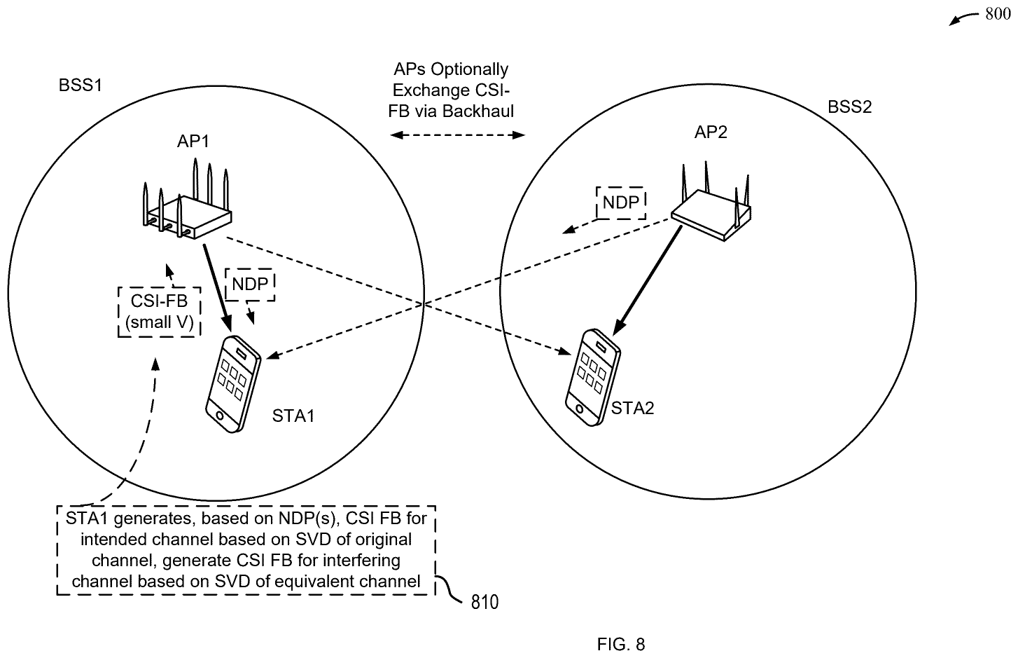

In this context, point-to-point channel feedback generally refers to the CSI feedback of a channel between two STAs, such as an AP and a non-AP STA (e.g., with a channel matrix Hᵢⱼ for APj and STAi). As will be described below with reference to FIG. 8 and FIG. 9, for point-to-point channel feedback, there are also various sub-options with different types of CSI processing (to generate the CSI feedback) and different types of content fed back (as CSI feedback).

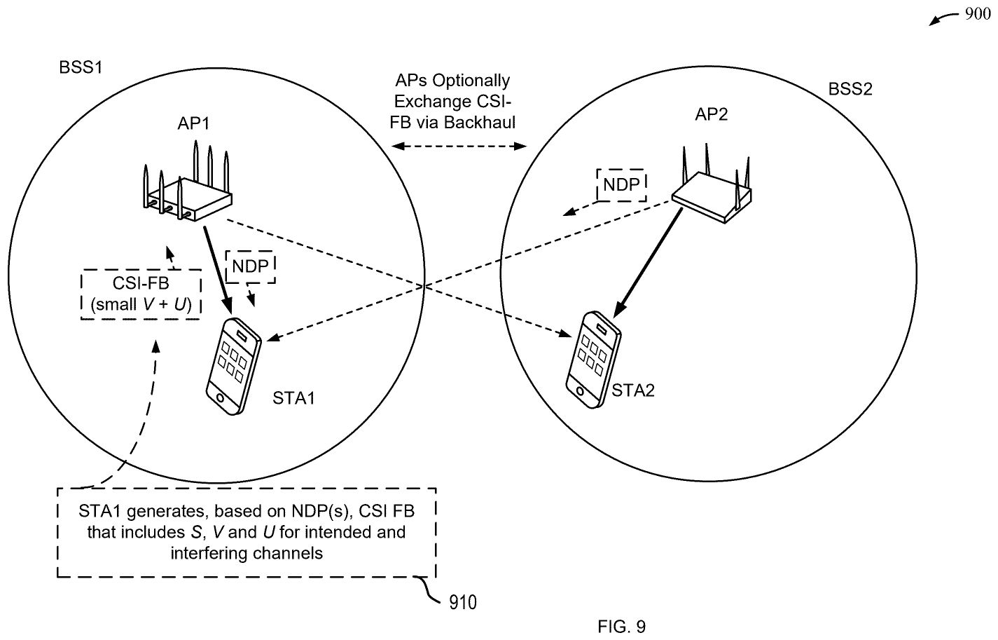

A composite channel may be either point to multi-point (e.g., from one AP to multiple non-AP STAs) or multi-point to single point (e.g., from multiple APs to a single STA). In this context, composite channel feedback generally refers to the CSI feedback of a composite channel, such as the channel from multiple APs (e.g., an in-BSS and OBSS AP) to a single STA (Hᵢ). As will be described below with reference to FIG. 10, aspects of the present disclosure provide techniques for a non-AP STA to generate composite channel CSI feedback and for an AP to reconstruct point-to-point channel CSI from the composite channel CSI feedback.

Point-to-point Channel CSI processing and feedback may be performed as follows. An N_{rx,i}×N_{tx,j} channel matrix from a j-th AP (APj) to an i-th STA (STAi) may be denoted as Hᵢⱼ where N_{rx,i} is the number of receive antennas of APj and N_{tx,j} is the number of transmit antennas from APj (and N_{rx,i}≤N_{tx,j}).

Based on the channel estimation of a packet (e.g., an NDP) from APj, STAi may obtain the channel matrix Hᵢⱼ and perform a singular value decomposition (SVD) on Hᵢⱼ to obtain: Hᵢⱼ=Uᵢⱼ·Sᵢⱼ·Vᵢⱼ′, where Uᵢⱼ is an N_{rx,i}×N_{rx,i} (left semi-unitary or) unitary matrix, Sᵢⱼ is an N_{rx,i}×N_{rx,i} diagonal matrix with the singular values of the channel Hᵢⱼ, and Vᵢ is an N_{tx,j}×N_{rx,i} (right) semi-unitary (or unitary) matrix.

In some cases, CSI feedback may be what is referred to as small V feedback. With small V feedback, STAi feeds back Sᵢⱼ and Vᵢⱼ of requested rank N_{fb,i} i.e., S_{fb,ij}=Sᵢⱼ(1:N_{fb,i}, 1:N_{fb,i}) and Vᵢⱼ=(:, 1:N_{fb,i}), where the requested rank may be signaled to the STA in a prior packet, e.g., NDPA. The notation of A(i:j, k:1) represents a submatrix of A, by selecting from the i-th to j-th rows and from the k-th to 1-th columns. The notation “:” in a submatrix A(:, k:l) represents a submatrix of A, by selecting all rows and from the k-th to 1-th columns. Likewise, the notation “:” in a submatrix A(i:j, :) represents a submatrix of A, by selecting from the i-th to j-th rows and all columns. In this manner, an AP may request CSI feedback (of certain matrices) to be of a certain rank (or number of columns). For example, an SVD may produce 4 Eigen channels, but the AP may only request a rank of 2 or 3 in a CSI feedback request.

In the case of small V feedback, the reconstructed channel rHᵢⱼ=S_{fb,ij}·V_{fb,ij}′ corresponds to the Eigen channels using the U_{nfb,ij}′ receiver (which is not fed back), where U_{nfb,ij}=Uᵢⱼ(:, 1:N_{fbi},). In this case, the full channel Hᵢⱼ may not be reconstructed, which may result in less than optimal CoBF.

According to one of the sub-options presented herein, however, STAi may use a CSI processing technique for the small V feedback of the intended and interfering channels based on the same receiver.

Referring to FIG. 8, an example of this first sub-option for point-to-point channel CSI processing and feedback is shown. The example assumes AP1 (BSS1) and AP2 (BSS2) transmit NDP(s) for sounding. As noted at 810, STA1 generates, based on the NDP(s), CSI FB for intended channel (between AP1 and STA1) based on SVD of original channel and generates CSI FB for interfering channel (between AP2 and STA1) based on an SVD of equivalent channel.

As illustrated, in some cases, STA1 may provide this (enhanced small V) CSI-FB to AP1. In some cases, STA1 may also provide this CSI-FB directly to AP2. In other cases, AP1 and AP2 may exchange CSI-FB (e.g., if a backhaul exists). For example, AP1 may transmit the CSI-FB for the interfering channel (between AP2 and STA1) to AP2 via a light backhaul. While not shown, STA2 may also generate CSI-FB for its intended channel (between AP2 and STA2) and interfering channel (between AP1 and STA2) and provide this CSI-FB to at least its AP (AP2).

This enhanced CSI processing for small V feedback according to this first sub-option may be described as follows, assuming the i-th AP is the serving AP of the i-th STA so that Hᵢᵢ is an intended channel and all other Hᵢⱼ where j≠i are interfering channels.

For intended channel Hᵢᵢ, STAi may feed back S_{fb,ii}=Sᵢᵢ(1:N_{fb,i}, 1:N_{fb,i}) and V_{fb,ii}=Vᵢᵢ(:, 1:N_{fb0i},) where N_{fb,i}=N_{ss,i}, where N_{ss,i} is the number of streams for the i-th STA that the i-AP intended to send in the CoBFed transmission, assuming using the eigen receiver U_{ss,ii}′ (not fed back) where U_{ss,ii}=Uᵢᵢ(:, 1:N_{ss,i}).

For interfering channel Hᵢⱼ where ≠i, the equivalent channel assuming the Eigen receiver at the i-th STA is U_{ss,ii}′ so that the equivalent channel from the j-th AP to the i-th STA after this Eigne receiver processing becomes U_{ss,ii}′Hᵢⱼ. For the CSI FB for the interfering channel, STAi may perform SVD on the equivalent channel U_{ss,ii}′Hᵢⱼ to obtain: U_{ss,ii}′Hᵢⱼ=U_{ss,ij}·S_{ss,ij}·V_{ss,ij}′, where U_{ss,ij} is an N_{ss,i}×N_{ss,i} unitary matrix, S_{ss,ij} is an N_{ss,i}×N_{ss,i} diagonal matrix with the singular values of the equivalent channel U_{ss,ii}′Hᵢⱼ, and V_{ss,i} is an N_{tx,j}×N_{ss,i} semi-unitary matrix. Feedback S_{fb,i,j}=S_{ss,ij} (1:N_{fb,i}, 1:N_{fb,i}) and V_{fb,ij}=V_{ss,ij} (:, 1:N_{fb,i}), where N_{fb,i}=N_{ss,i}.

A distinction between the enhanced small V feedback according to this first sub-option and typical V feedback is that the enhanced feedback (for the interfering channels) is based on the SVD of the equivalent channel U_{ss,ii}′Hᵢⱼ instead of the SVD of the original channel Hᵢⱼ. In this way, the same receiver U_{ss,ii}′Hᵢⱼ is assumed for intended and interfering channels. In this example, it is assumed that the Eigen receiver U_{ss,ii}′ is used to generate both the CSI FB for the intended channel Hᵢᵢ and the CSI FB for the interfering equivalent channel U_{ss,ii}′Hᵢⱼ. A more general case in the enhanced feedback is to use a same linear receiver Gᵢ to generate both the CSI FB for the intended equivalent channel GᵢHᵢᵢ and the CSI FB for the interfering equivalent channel GᵢHᵢⱼ.

According to another of the sub-options presented herein, however, STAi may feedback U, S, and V from the SVD of the point-to-point channel. For example, STAi may feed back Uᵢⱼ, Sᵢⱼ and Vᵢⱼ of a requested rank N_{fb,i}, i.e., U_{nfb,ij} (e.g., fed back in this case), S_{fb,ij} and V_{fb,ij}.

Referring to FIG. 9, an example of this second sub-option for point-to-point channel CSI processing and feedback is shown. As noted at 910, in this case, STA1 generates CSI FB that includes S, V and U for intended and interfering channels. The STA may then provide the CSI-FB (which may be referred to as small V plus U) to at least AP1.

In this case, at APj, the reconstructed channel rHᵢⱼ=U_{nfb,ij}·S_{fb,ij}·V_{fb,ij}′ is the original channel in full rank feedback, and is an approximation of the original channel (with dominant Eigen modes) in partial rank feedback. The rank of transmission to the i-th STA intended in the CoBFed transmission is N_{ss,i}, where, in general, N_{ss,i}≤N_{fb,i}≤N_{rx,i}.

Referring to FIG. 10, an example of composite channel CSI processing and feedback is shown. As noted at 1010, in this case, STA1 generates CSI FB based on SVD of a composite channel matrix. In this context, a composite channel matrix generally refers to a channel matrix that represents the channel from all APs to the same non-AP STA. The composite channel matrix may be obtained by combining (stacking) all the point-to-point channel matrices, where each is from one AP to the non-AP STA, into a big matrix or could be obtained from channel estimate when processing a single packet (e.g., joint NDP) sent from both the first and second wireless nodes using a joint LTF.

Composite channel CSI processing and feedback may be performed as follows. The composite channel matrix at the i-th STA from Nₐₚ APs may be denoted as Hᵢ=[Hᵢ₁ Hᵢ₂ . . . H_{iNap}]. The i-th STA may perform SVD on Hᵢ to obtain: Hᵢ=Uᵢ·Sᵢ·Vᵢ′, where Uᵢ is an N_{rx,i}×N_{rx,i} unitary matrix, Sᵢ is an N_{rx,i}×N_{rx,i} diagonal matrix with the singular values of the channel, and Vᵢ is an (N_{tx,1}+N_{tx,2}+ . . . +N_{tx,N}_{ₐₚ})×N_{rx,i} semi-unitary matrix.

In what may be referred to as large V feedback, the i-th STA may feed back Sᵢ and Vᵢ of requested rank N_{fb,i}, i.e., S_{fb,i}=Sᵢ(1:N_{fb,i}, 1:N_{fb,i}) and V_{fb,i}=Vᵢ(:, 1:N_{fb,i}).

At an AP, the reconstructed composite channel rHᵢ=S_{fb,i}·V_{fb,i}′ corresponds to the eigen channels using the U_{n,fb,i}′ receiver (not fed back), where U_{nfb,i}=Uᵢ(:, 1:N_{fb,i}). In may be noted that rHᵢ=U_{nfb,i}′Hᵢ=[U_{nfb,i}′·Hᵢ₁, U_{nfb,i}′·Hᵢ₂, . . . , U_{nfb,i}′·Hᵢⱼ, . . . ]=[rHᵢ₁, rHᵢ₂, . . . , rHᵢⱼ, . . . ], where rHᵢⱼ=U_{nfb,i}′Hᵢⱼ is the equivalent channel from the j-th AP to the i-th STA assuming using the U_{nfb,i}′ receiver (same receiver assumed for intended and interfering channels). Thus, different subsets of columns in the reconstruction composite channel rHᵢ correspond to different reconstruction channels rHᵢⱼ.

Reconstruction of point-to-point channel CSI from the composite channel CSI feedback may be as follows. In this case, rHᵢⱼ=U_{nfb,i}′·Hᵢⱼ is the equivalent channel from the j-th AP to the i-th STA assuming using the U_{nfb,i}′ receiver, and it is taken from columns corresponding to the Tx antennas from the j-th AP in the reconstruction composite channel rHᵢ.

SVD may be performed on the reconstructed channel matrix rHᵢⱼ=rUᵢⱼ·rSᵢⱼ·rVᵢⱼ′, where rUᵢⱼ is an N_{fb,i}×N_{fb,i} unitary matrix, rSᵢⱼ is an N_{fb,i}×N_{fb,i} diagonal matrix with the singular values of the reconstructed channel rHᵢⱼ and rVᵢⱼ is an N_{tx,j}×N_{fb,i} semi-unitary matrix. rSᵢⱼ and rVᵢⱼ is the point-to-point channel CSI in the form of small V feedback.

As described herein, the content and quantity of CSI feedback provided by different non-AP STAs may vary.

For example, in some cases, a non-AP STA is able to estimate the intended channel and the interfering channel(s) but is not able to process them jointly. This may be the case, for example, in the scenario of sequential sounding NDP and CSI feedback may happen after each sounding NDP. One STA may have to send CSI feedback of the interfering channel (from an interfering AP) before that STA could estimate the intended channel from own AP. In some cases, the STA could use small V feedback (e.g., without the enhancements proposed herein) or small U plus V feedback of each point-to-point channel. In this case, CSI from each non-AP STA may be sent to different APs directly, or sent to its serving AP and then relayed to interfering AP(s) through backhaul.

In some cases, a non-AP STA may be able to estimate the intended channel and the interfering channel(s) and process them jointly. This may be the scenario of sequential sounding NDP (and CSI feedback happens after receiving sounding NDPs from all APs or at least after the STA could estimate the intended channel from own AP) or the scenario of joint NDP when signaling indicates which part of composite channel comes from which AP. In such cases, the non-AP STA may send small V feedback (e.g., without the enhancements proposed herein) or small U plus V feedback of each point-to-point channel.

Alternatively, the non-AP STA could perform the enhanced CSI processing for small V feedback described above. In this case, the CSI feedback is still point-to-point channel CSI. Further, CSI from each non-AP STA may be sent to different APs directly, or sent to its serving AP and then relayed to interfering AP(s) through backhaul, as noted above.

In some cases, the non-AP STA may only be able to estimate the composite channel. This may be the scenario of joint NDP when there is no signaling to indicate which part of composite channel comes from which AP. In this case, the non-AP STA may send the large V (composite) feedback to its own AP and interfering AP(s). As an alternative, if there is a backhaul between APs, the non-AP STA may send the large V feedback to its own (serving) AP. In this case, its serving AP could reconstruct the point-to-point channel CSI of the interfering channel(s) and send the CSI feedback of each interfering channel to each of the corresponding interfering AP(s).

### Example Enhancements for Sounding and CSI Feedback for CoBF

Aspects of the present disclosure may provide various enhancements for sounding and CSI feedback for CoBF.

For example, aspects of the present disclosure provide process techniques for reducing CSI feedback overhead, in cases where the CSI feedback of the channels from one OBSS AP to multiple in-BSS STAs is relayed in backhaul through the associated AP of these STAs. The processing techniques may be considered novel CSI processing techniques to reduce MU CSI feedback overhead.

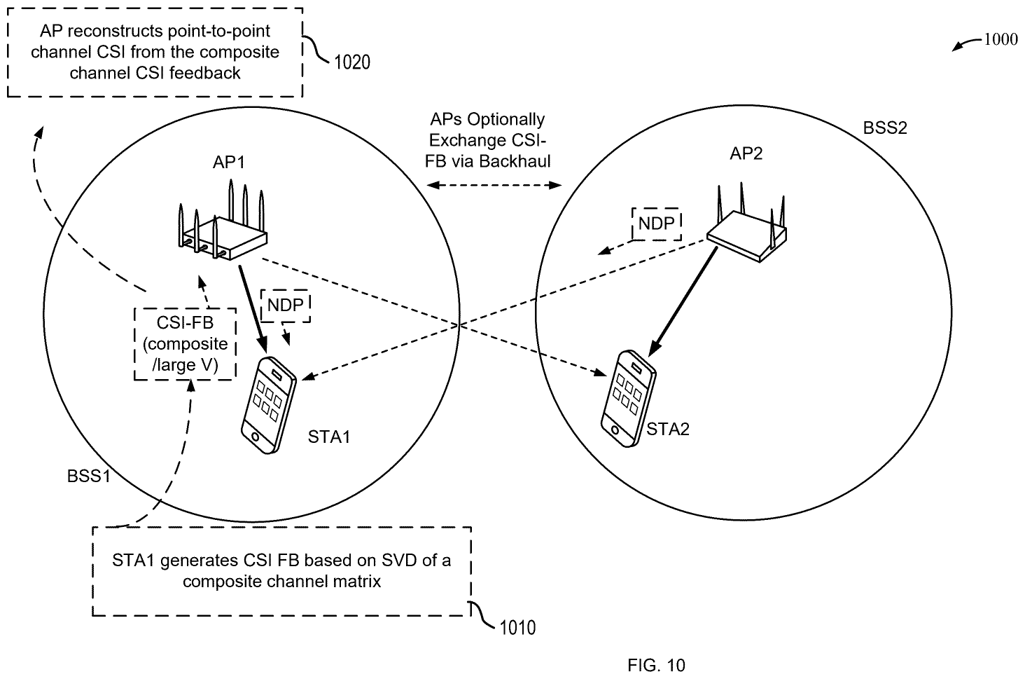

Referring to FIG. 11, an example of compressing CSI FB relayed via a backhaul is shown. The example assumes STA1 and STA2 are both associated with AP1.

As noted at 1110 and 1112, in this case, STA1 and STA2 (in the BSS of AP1) may both generate CSI FB based on NDPs from AP1 and AP2. STA1 and STA2 may both provide the CSI FB to AP1.

As noted at 1120, AP1 may compress the CSI FB from STA1 and STA2 and forward the compressed CSI feedback to AP2. As noted at 1130, AP2 may use the compressed CSI feedback received from AP1 (e.g., to form nulls to the STA1 and STA2).

In this manner, if the CSI feedback of the channels from one OBSS AP to multiple in-BSS STAs is relayed in backhaul through the associated AP of these STAs, the enhanced CSI processing and signaling mechanisms proposed herein may help reduce CSI feedback overhead on the backhaul.

The exact form of the CSI processing to compress the CSI feedback may vary depending on the type of feedback.

For example, a sharing AP (e.g., AP1 in FIG. 11) may perform one type of CSI processing for compression if the CSI feedback is in the form of small V feedback (S_{fb,ij} and V_{fb,ij}) of a requested rank (e.g., N_{fb,i}), for channel from the j-th AP to the i-th STA, and S_{fb,kj} and V_{fb,kj} of requested rank N_{fb,k}, for channel from the j-th AP to the k-th STA.

In this context, S_{fb,ij} may have a dimension of N_{fb,i}×N_{fb,i}, and V_{fb,ij} may have a dimension of N_{tx,j}×N_{fb,i}. S_{fb,kj} may have a dimension of N_{fb,k}×N_{fb,k}, and V_{fb,kj} may have a dimension of N_{tx,j}×N_{fb,k}. It may be noted that V_{fb,ij} and V_{fb,kj} are usually neither orthogonal nor are they aligned.

Processing to compress the CSI FB at the AP associated with these two STAs (e.g., AP1 in FIG. 11), may be performed as follows. The AP may reconstruct the composite channel from the j-th AP to both STAs as:

$$r {H}_{i \& k , j} = [ {S}_{i j} \cdot {V}_{i j}^{′} {S}_{k j} \cdot {V}_{k j}^{′} ] ,$$

having dimension of (N_{fb,i}+N_{fb,k})×N_{tx,j}. The AP may then perform SVD on this reconstructed composite channel to obtain:

$$r {H}_{i \& k , j} = r {U}_{i \& k , j} \cdot {rS}_{i \& k , j} \cdot {rV}_{i \& k , j}^{′} ,$$

where rU_{i&k,j} is an (N_{fb,i}+N_{fb,k})×(N_{fb,i}+N_{fb,k}) unitary matrix, rS_{i&k,j} is an (N_{fb,i}+N_{fb,k})×(N_{fb,i}+N_{fb,k}) diagonal matrix with the singular values of the reconstructed composite channel, and rV_{i&k,j} is an N_{tx,j}×(N_{fb,i}+N_{fb,k}) semi-unitary matrix.

The associated AP of these two STAs may then send the small V feedback of rS_{i&k,j} and rV_{i&k,j} to the j-th AP, instead of sending S_{fb,ij}, V_{fb,ij}, S_{fb,kj} and V_{fb,kj}. For example, referring again to FIG. 11, AP1 may send the small V feedback to AP2.

A sharing AP (e.g., AP1 in FIG. 11) may perform a different type of CSI processing for compression if the CSI feedback is in the form of large V feedback. As noted above, in this context large V feedback may include S_{fb,i} and V_{fb,i} of a requested rank N_{fb,i}, for the composite channel from multiple APs to the i-th STA, and S_{fb,k} and V_{fb,k} of requested rank N_{fb,k}, for composite channel from multiple APs to the k-th STA.

In this case, the reconstructed composite channel may be:

$${rH}_{i} = {S}_{fb , i} \cdot {V}_{f b , i}^{′} = [ {U}_{nfb , i}^{′} \cdot {H}_{i 1} , {U}_{nfb , i}^{′} , {H}_{i 2} , … , {U}_{nfb , i}^{′} \cdot {H}_{ij} , … ] = [ {rH}_{i 1} , {rH}_{i 2} , … , {rH}_{ij} , … ] ,$$

where rHᵢⱼ=U_{nfb,i}′·Hᵢⱼ is the equivalent channel from the j-th AP to the i-th STA assuming using the U_{nfb,i}′ receiver (not fed back).

The associated AP of these two STAs may then reconstruct the composite channel from the j-th AP to both STAs as:

$${rH}_{i \& k , j} = [ {rH}_{i j} {rH}_{k j} ] ,$$

having dimension of (N_{fb,i}+N_{fb,k})×N_{tx,j}. The sharing AP may then perform an SVD on this reconstructed composite channel to obtain:

$${rH}_{i \& k , j} = {rU}_{i \& k , j} \cdot {rS}_{i \& k , j} \cdot {rV}_{i \& k , j}^{′} .$$

The associated AP of these two STAs could send the small V feedback of rS_{i&k,j} and rV_{i&k,j} to the j-th AP.

Potential savings in backhaul CSI feedback overhead may be understood by considering some example scenarios. According to a first example scenario:

$${N}_{tx , j} = 4 , {N}_{fb , i} = {N}_{fb , k} = 1.$$

In this case, the shared AP would feed back a total 10 angles (5 Phi's and 5 Psi's) for 4×2 instead of total 12 angles (6 Phi's and 6 Psi's) for two 4×1, resulting in a reduction of 2 out of 12 for a 16.7% overhead savings. According to a second example scenario:

$${N}_{tx , j} = 5 , {N}_{fb , i} = {N}_{fb , k} = 1.$$

In this case, the shared AP may feedback a total of 14 angles (7 Phi's and 7 Psi's) for 5×2 instead of total 16 angles (8 Phi's and 8 Psi's) for two 5×1, resulting in a reduction of 2 out of 16, for a 12.5% overhead savings.

Aspects of the present disclosure also provide various signaling mechanisms to help enable the enhanced CSI processing described herein.

Certain joint or sequential sounding protocols may assume that the (non-AP) STAs know that the NDP comes from an OBSS AP or that the joint NDP comes from a group of APs. Thus, the STAs may be expected to respond to a sounding request from an OBSS AP or a group of APs.

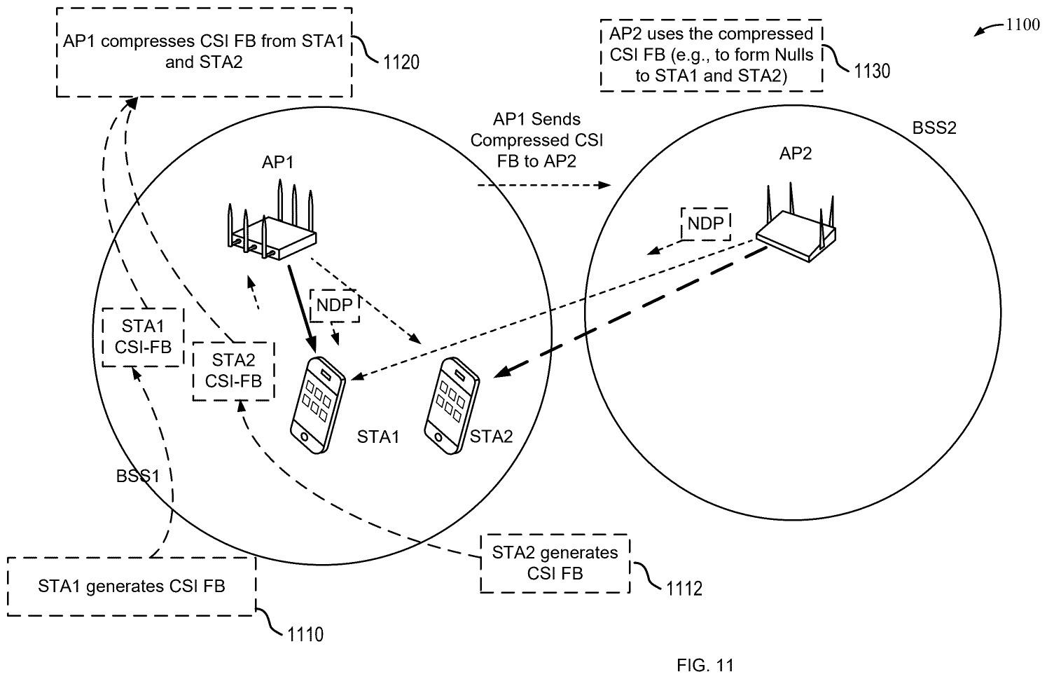

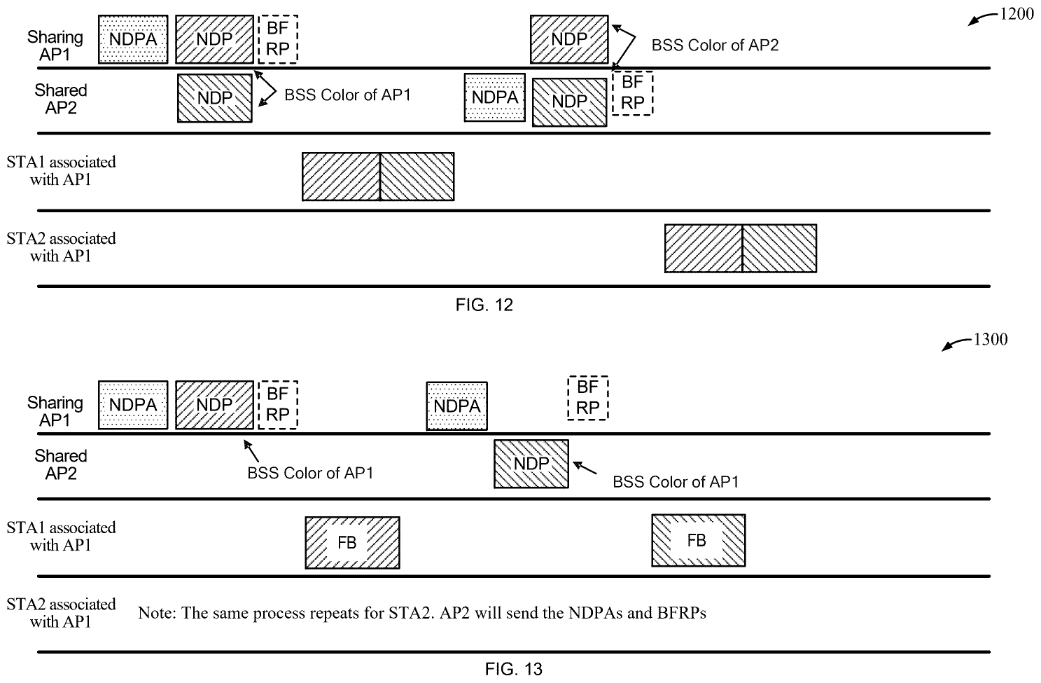

Unfortunately, current wireless systems may not have signaling mechanisms to support this type of cross-BSS sounding and feedback. Aspects of the present disclosure, however, propose signaling mechanisms that can support cross-BSS sounding for the case of joint sounding (as will be described with reference to FIG. 12), as well as sequential sounding (as will be described with reference to FIG. 13), by essentially using NDP sounding that pretends to be “in-BSS” even when NDPs are transmitted by an OBSS AP.

The signaling mechanisms proposed herein essentially represent two sounding protocols and a signaling design in each to enable the enhanced CSI processing proposed herein. As noted above, in the enhanced CSI processing, a non-AP STA derives its MIMO receiver according to its desired channel (the channel from its own AP to itself), and perform an SVD on an equivalent interfering channel (the channel from an interfering AP to itself, assuming using its MIMO receiver) to derive the small V feedback for that interfering channel.

Aspects of the present disclosure provide signaling that allows a non-AP STA to differentiate the desired channel (from own AP) and the interfering channel (from an interfering AP), so that the non-AP STA can process CSI accordingly.

Referring to timing diagram 1200 of FIG. 12, sounding typically happens one BSS at a time (to collect feedback from the STAs in a given BSS). The example in FIG. 12 shows a relative simple scenario of 2 APs (AP1 and AP2) and 1 (non-AP) STA per AP (with STA1 associated with AP1 and STA 2 association with AP2).

As illustrated, an NDPA is sent from only one AP (which may be referred to as a “sounding AP”). As described above, the joint NDP, even though sent from both APs, pretends to be an NDP sent from a single “sounding AP”. As a result, only STAs associated with the sounding AP will respond with CSI feedback.

Aspects of the present disclosure, however, provide a signaling design to enable novel CSI processing.

As illustrated in FIG. 12, the NDPs after each NDPA signals the BSS color of the AP that sends out the NDPA in U-SIG. After the NDPA sent by AP1, both AP1 and AP2 use the BSS color of AP1 when participating in the joint NDP so as to pretend that the joint NDP is sent from AP1. Similarly, after the NDPA sent by AP2, both AP1 and AP2 use the BSS color of AP2 when participating in the joint NDP so as to pretend that the joint NDP is sent from AP2.

Additional information may be conveyed/signaled in the NDPA or NDP (e.g., via the U-SIG or EHT-SIG fields). As an example, a number (quantity) of APs in sounding (e.g., denoted as Nₐₚ) and a number (quantity) of spatial streams of each AP in the NDP, [N_ss_1, N_ss_2, . . . ], may be conveyed.

In some cases, the information may include a list of CoBF sounding BSS IDs, or one or more bitmaps. For example, a bitmap indication of a group of CoBF sounding BSSs may use a first value (e.g., “1”) to indicate one of the APs in the group of CoBF sounding APs is an associated AP and a second value (e.g., “0”) to indicate one of the APs in the group of CoBF sounding APs is an interfering AP.

As another or example, a bitmap indication could indicate which spatial streams are from a STAs own AP or from an interfering AP. For example, a first value (e.g., “1”) may indicate a corresponding spatial stream is transmitted by an associated AP and a second value (e.g., “0”) may indicate the corresponding spatial stream is transmitted by an interfering AP. This approach may work, as the STA only needs to differentiate the intended channel and interfering channel. In a CoBF scenario with only two APs, the STA does not actually need to know the BSS color of the interfering AP.

In some cases of a sequential sounding protocol, sounding may happen one BSS pair at a time (e.g., to collect feedback from the STAs in a first BSS, based on the NDPs from an AP in a second BSS). In this context, the first and second BSSs could be the same or different BSSs.

The example timeline 1300 in FIG. 13 shows an example of a sequential sounding protocol. The example again assumes 2 APs (AP1 and AP2) and 1 (non-AP) STA per AP (with STA1 associated with AP1 and STA 2 association with AP2).

As illustrated in FIG. 13, in this case, the NDPA may be sent from only one AP (“sounding AP”), AP1 in this example. Optionally, beamforming response poll (BF RPs) may be used as triggering frames. The NDP, which may be sent from a different AP, pretends to be an NDP sent from the “sounding AP”. As shown, when AP2 sends its NDP, it uses the BSS color of AP1 (since AP1 sent the NDPA). As a result, only STAs associated with the sounding AP will respond with CSI feedback (STA1 in this example).

In some cases, there may be an assumption that the own AP sends NDP before an interfering AP does. This may help a STA know whether an NDP corresponds to a desired or interfering channel. In general, as illustrated in FIG. 13, each NDP may signal the BSS color of the AP that sends out the NDPA in U-SIG. Each NDP may also signal the BSS color of the AP that sends out the NDP, in U-SIG or UHR-SIG, to enable the STA to differentiate an AP corresponding to a desired or interfering channel.

While not shown, the same process may be repeated for STA2. In this case, AP2 will send the NDPAs (and, optionally, BF RPs), such that both AP1 and AP2 will use the BSS color of AP2 when sending their NDPs. As a result, STA2 will respond to each NDP, essentially considering it an in-BSS NDP.

Various other information may be signaled in the NDPA or NDP (e.g., U-SIG or EHT-SIG). For example, the information may include the BSS color of the true AP that sends out the NDP. In some cases, the information could include a 1-bit indication, where a first value (e.g., a “1”) indicates an NDP is from an associated AP, while a second value (e.g., a “0”) indicates an NDP is from an interfering AP.

### Example Methods

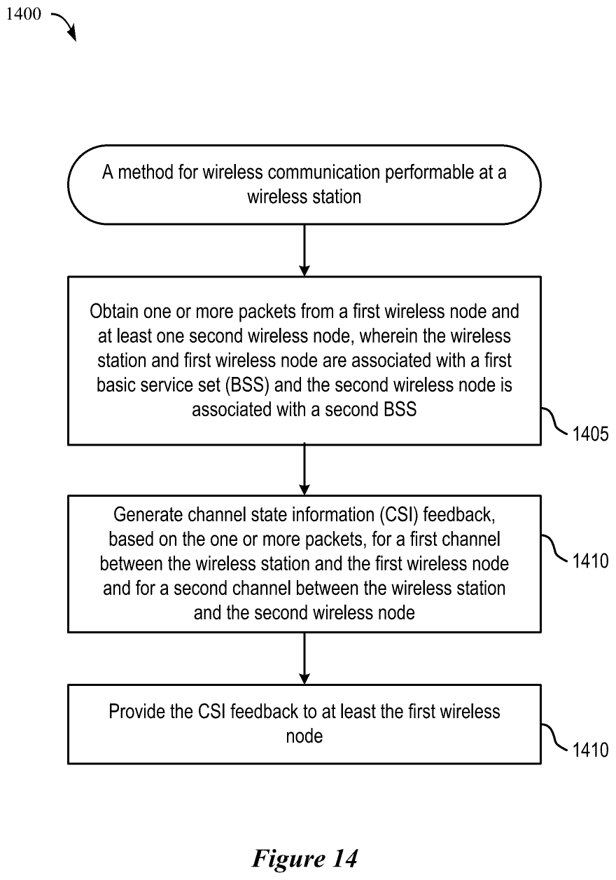

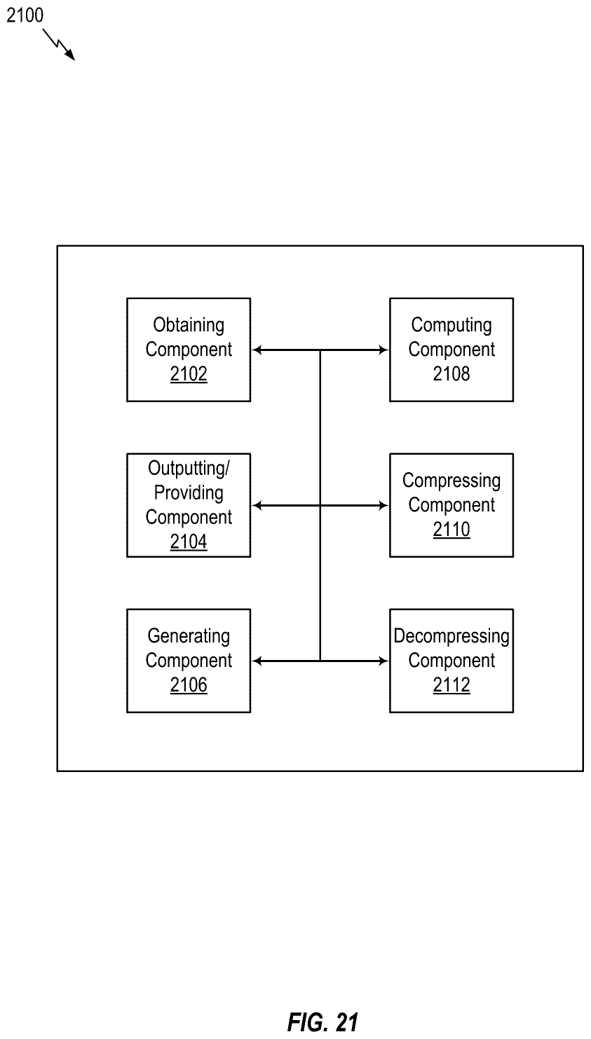

FIG. 14 shows an example of a process or method 1400 of wireless communication performable by or at a first wireless station. The operations of the process 1400 may be implemented by a wireless station or its components as described herein. For example, the process 1400 may be performed by a wireless communication device, such as the wireless communication device 2100 described with reference to FIG. 21, operating as or within a wireless station.

Method 1400 begins at step 1405 with obtaining one or more packets from a first wireless node and at least one second wireless node, wherein the wireless station and the first wireless node are associated with a first basic service set (BSS) and the second wireless node is associated with a second BSS.

Method 1400 then proceeds to step 1410 with generating CSI feedback, based on the one or more packets, for a first channel between the wireless station and the first wireless node and for a second channel between the wireless station and the second wireless node.

Method 1400 then proceeds to step 1415 with providing the CSI feedback to at least the first wireless node.

In some aspects, the CSI feedback is also provided directly from the wireless station to the second wireless node.

In some aspects, the method 1400 further includes obtaining signaling indicating a requested rank for the CSI feedback, wherein the provided CSI feedback is of the requested rank.

In some aspects, the one or more packets comprise first and second packets obtained sequentially from the first wireless node and second wireless node.

In some aspects, generating the CSI feedback comprises: performing a singular value decomposition (SVD) of an original channel matrix for the first channel to obtain a first matrix that is a left semi-unitary or a unitary matrix, a second matrix that is a diagonal real matrix, and a third matrix that is a right semi-unitary or a unitary matrix, wherein the CSI feedback for the first channel is based on the second matrix and the third matrix; and performing an SVD of an equivalent channel matrix for the second channel to obtain a fourth matrix that is a left semi-unitary or a unitary matrix, a fifth matrix that is a diagonal real matrix, and a sixth matrix that is a right semi-unitary or a unitary matrix, wherein the CSI feedback for the second channel is based on the fifth matrix and the sixth matrix.

In some aspects, the equivalent channel matrix for the second channel assumes a same linear receiver associated with processing the original channel matrix for the first channel.

In some aspects, the linear receiver is formed by one or more dominant left-singular vectors of the original channel matrix for the first channel.

In some aspects, the CSI feedback comprises: performing a singular value decomposition (SVD) of a first channel matrix for the first channel to obtain a first matrix that is a left semi-unitary or a unitary matrix, a second matrix that is a diagonal real matrix, and a third matrix that is a right semi-unitary or a unitary matrix, wherein the CSI feedback for the first channel is based on the first matrix, the second matrix, and the third matrix; and performing an SVD of a second channel matrix for the second channel to obtain a fourth matrix that is a left semi-unitary or a unitary matrix, a fifth matrix that is a diagonal real matrix, and a sixth matrix that is a right semi-unitary or a unitary matrix, wherein the CSI feedback for the second channel is based on the fourth matrix, the fifth matrix, and the sixth matrix.

In some aspects, the one or more packets comprise one or more null data packets (NDPs) obtained from the first and second wireless nodes; and generating the CSI feedback comprises: generating a composite channel matrix, based on the one or more NDPs, and performing a singular value decomposition (SVD) of the composite channel matrix to obtain a first matrix that is a left semi-unitary or unitary matrix, a second matrix that is a diagonal real matrix, and a third matrix that is a right semi-unitary or unitary matrix, wherein the CSI feedback is based on at least the second matrix and the third matrix.

In some aspects, the composite channel matrix is generated based on: a first channel matrix for the first channel between the wireless station and the first wireless node; and a second channel matrix for the second channel between the wireless station and the second wireless node.

In some aspects, the one or more NDPs comprise a joint NDP that has: one or more fields with same information from both the first and second wireless nodes; and at least one training field with a first subset of one or multiple spatial streams from the first wireless node and a second subset of one or multiple spatial streams from the second wireless node.

In some aspects, the method 1400 further includes obtaining information indicating the first subset and the second subset.

In some aspects, the information is obtained via a NDP announcement (NDPA) frame, or the one or more NDPs.

In some aspects, the information comprises at least one of: a quantity of transmit antennas used by each of the first and second wireless nodes; or a quantity of streams from each of the first and second wireless nodes.

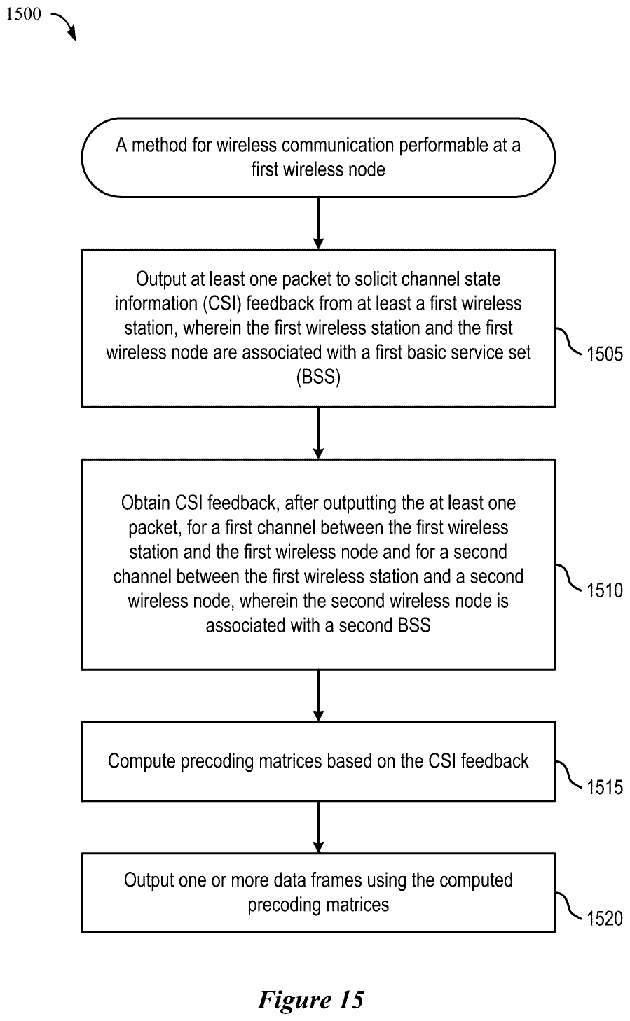

FIG. 15 shows an example of a process or method 1500 of wireless communication performable by or at a first wireless node. The operations of the process 1500 may be implemented by a wireless node or its components as described herein. For example, the process 1500 may be performed by a wireless communication device, such as the wireless communication device 2100 described with reference to FIG. 21, operating as or within a wireless node.

Method 1500 begins at step 1505 with outputting at least one packet to solicit channel state information (CSI) feedback from at least a first wireless station, wherein the first wireless station and the first wireless node are associated with a first basic service set (BSS).

Method 1500 then proceeds to step 1510 with obtaining CSI feedback, after outputting the at least one packet, for a first channel between the first wireless station and the first wireless node and for a second channel between the first wireless station and a second wireless node, wherein the second wireless node is associated with a second BSS.

Method 1500 then proceeds to step 1515 with computing precoding matrices based on the CSI feedback.

Method 1500 then proceeds to step 1520 with outputting one or more data frames using the computed precoding matrices.

In some aspects, the method 1500 further includes providing the CSI feedback for the second channel to the second wireless node.

In some aspects, the method 1500 further includes obtaining, from the second wireless node, CSI feedback for a third channel between a second wireless station and the first wireless node.

In some aspects, the method 1500 further includes providing the first wireless station signaling indicating a requested rank for the CSI feedback, wherein the obtained CSI feedback is of a requested rank.

In some aspects, the CSI feedback for the first channel comprises a second matrix that is a diagonal real matrix, and a third matrix that is a right semi-unitary or a unitary matrix, wherein the second matrix and the third matrix are based on a singular value decomposition (SVD) of an original channel matrix for the first channel; and the CSI feedback for the second channel comprises a fifth matrix that is a diagonal real matrix, and a sixth matrix that is a right semi-unitary or a unitary matrix, wherein the fifth matrix and the sixth matrix are based on an SVD of an equivalent channel matrix for the second channel.

In some aspects, the method 1500 further includes providing the CSI feedback for the second channel to the second wireless node.

In some aspects, the equivalent channel matrix for the second channel assumes a same linear receiver associated with processing the original channel matrix for the first channel.

In some aspects, the CSI feedback for the second channel comprises a first matrix that is a diagonal real matrix, and a second matrix that is a right semi-unitary or a unitary matrix, wherein the first matrix and the second matrix are based on an SVD of a channel matrix for the second channel; and the method further comprises providing the CSI feedback for the second channel to the second wireless node.

In some aspects, the method 1500 further includes obtaining, from the second wireless node, CSI feedback for a third channel between a second wireless station and the first wireless node, wherein the second wireless station is associated with the second BSS.

In some aspects, the CSI feedback for the first channel comprises a first matrix that is a left semi-unitary or a unitary matrix, a second matrix that is a diagonal real matrix, and a third matrix that is a right semi-unitary or a unitary matrix, wherein the first matrix, the second matrix, and the third matrix are based on a singular value decomposition (SVD) of an original channel matrix for the first channel; and the CSI feedback for the second channel comprises a fourth matrix that is a left semi-unitary or a unitary matrix, a fifth matrix that is a diagonal real matrix, and a sixth matrix that is a right semi-unitary or a unitary matrix, wherein the fourth matrix, the fifth matrix, and the sixth matrix are based on an SVD of an equivalent channel matrix for the second channel.

In some aspects, the method 1500 further includes reconstructing the second channel based on the CSI feedback for the second channel.

In some aspects, the method 1500 further includes reconstructing the equivalent channel matrix for the reconstructed second channel wherein the equivalent channel matrix for the reconstructed second channel assumes a same linear receiver associated with processing the original channel matrix for the first channel, wherein the linear receiver is formed by one or more dominant left-singular vectors of the original channel matrix for the first channel, based on the CSI feedback for the first channel.

In some aspects, the method 1500 further includes performing an SVD of the equivalent channel matrix for the reconstructed second channel to obtain a seventh matrix that is a diagonal real matrix and an eighth matrix that is a right semi-unitary or a unitary matrix.

In some aspects, the method 1500 further includes providing CSI feedback, based on the seventh matrix and the eighth matrix, to the second wireless node.

In some aspects, the at least one packet comprises at least one null data packet (NDP); and the CSI feedback comprises at least a second matrix that comprises a diagonal real matrix, and a third matrix that comprises a right semi-unitary or unitary matrix, wherein the second matrix and the third matrix are based on an SVD of a composite channel matrix.

In some aspects, the composite channel matrix is based on: a first channel matrix for the first channel between the wireless station and the first wireless node; and a second channel matrix for the second channel between the wireless station and the second wireless node.

In some aspects, the method 1500 further includes reconstructing the equivalent channel matrix for the second channel based on the CSI feedback.

In some aspects, the method 1500 further includes performing an SVD of the equivalent channel matrix for the reconstructed second channel to obtain a fourth matrix that is a diagonal real matrix and a fifth matrix that is a right semi-unitary or a unitary matrix.

In some aspects, the method 1500 further includes providing CSI feedback, based on the fourth matrix and the fifth matrix, to the second wireless node.

In some aspects, the at least one NDP comprise a joint NDP output in coordination with the second wireless node, wherein the joint NDP has: one or more fields with same information from both the first and second wireless nodes; and at least one training field with a first subset of one or multiple spatial streams from the first wireless node and a second subset of one or multiple spatial streams from the second wireless node.

In some aspects, the method 1500 further includes providing information indicating the first subset and the second subset.

In some aspects, the information is provided via a NDP announcement (NDPA) frame, or the at least one NDP.

In some aspects, the information comprises at least one of: a quantity of transmit antennas used by each of the first and second wireless nodes; or a quantity of streams from each of the first and second wireless nodes.

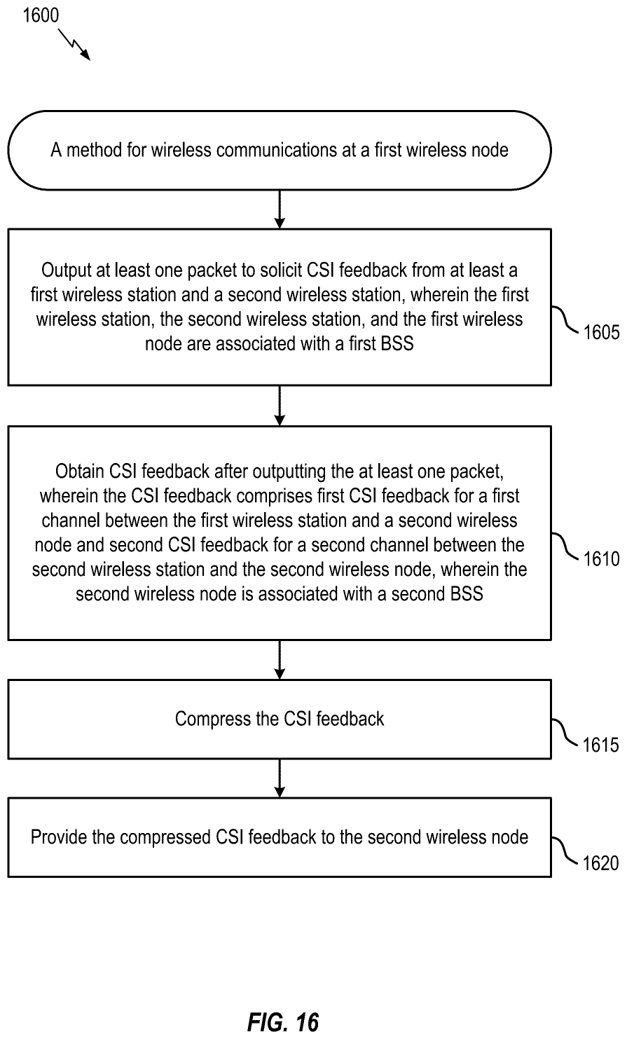

FIG. 16 shows an example of a process or method 1600 of wireless communication performable by or at a first wireless node. The operations of the process 1600 may be implemented by a wireless node or its components as described herein. For example, the process 1600 may be performed by a wireless communication device, such as the wireless communication device 2100 described with reference to FIG. 21, operating as or within a wireless node.

Method 1600 begins at step 1605 with outputting at least one packet to solicit CSI feedback from at least a first wireless station and a second wireless station, wherein the first wireless station, the second wireless station, and the first wireless node are associated with a first BSS. In some cases, the operations of this step refer to, or may be performed by, circuitry for outputting and/or code for outputting as described with reference to FIG. 21.

Method 1600 then proceeds to step 1610 with obtaining CSI feedback after outputting the at least one packet, wherein the CSI feedback comprises first CSI feedback for a first channel between the first wireless station and a second wireless node and second CSI feedback for a second channel between the second wireless station and the second wireless node, wherein the second wireless node is associated with a second BSS. In some cases, the operations of this step refer to, or may be performed by, circuitry for obtaining and/or code for obtaining as described with reference to FIG. 21.

Method 1600 then proceeds to step 1615 with compressing the CSI feedback. In some cases, the operations of this step refer to, or may be performed by, circuitry for compressing and/or code for compressing as described with reference to FIG. 21.

Method 1600 then proceeds to step 1620 with providing the compressed CSI feedback to the second wireless node. In some cases, the operations of this step refer to, or may be performed by, circuitry for providing and/or code for providing as described with reference to FIG. 21.

In some aspects, the method 1600 further includes providing, to the first wireless station and the second wireless station, signaling indicating a requested rank for the CSI feedback, wherein the obtained CSI feedback is of the requested rank. In some cases, the operations of this step refer to, or may be performed by, circuitry for providing and/or code for providing as described with reference to FIG. 21.

In some aspects, the first CSI feedback for the first channel comprises information regarding a first matrix and a second matrix, wherein the first matrix and the second matrix are based on a SVD of an equivalent first channel matrix; and the second CSI feedback for the second channel comprises information regarding a third matrix and a fourth matrix, wherein the third matrix and the fourth matrix are based on an SVD of an equivalent second channel matrix.

In some aspects, the first matrix comprises a diagonal real matrix and the second matrix comprises a right semi-unitary or a unitary matrix; and the third matrix comprises a diagonal real matrix and the fourth matrix comprises a right semi-unitary or a unitary matrix.

In some aspects, the method 1600 further includes reconstructing a composite channel based on the information regarding the first matrix, the second matrix, the third matrix, and the fourth matrix. In some cases, the operations of this step refer to, or may be performed by, circuitry for reconstructing and/or code for reconstructing as described with reference to FIG. 21.

In some aspects, compressing the CSI feedback comprises performing an SVD of a composite channel matrix for the reconstructed composite channel.

In some aspects, the compressed CSI feedback comprises information regarding a fifth matrix and a sixth matrix generated by the SVD of the composite matrix, wherein the fifth matrix comprises a diagonal real matrix and the sixth matrix comprises a right semi-unitary or a unitary matrix.

In some aspects, the first CSI feedback for the first channel comprises information regarding a first matrix and a second matrix, wherein the first matrix and the second matrix are based on a SVD of a first composite channel matrix; and the second CSI feedback for the second channel comprises information regarding a third matrix and a fourth matrix, wherein the third matrix and the fourth matrix are based on an SVD of a second composite channel matrix.

In some aspects, the first matrix comprises a diagonal real matrix and the second matrix comprises a right semi-unitary or a unitary matrix; and the third matrix comprises a diagonal real matrix and the fourth matrix comprises a right semi-unitary or a unitary matrix.

In some aspects, the first composite channel matrix is based on a first channel matrix for the first channel between the first wireless station and the second wireless node and a third channel matrix for a third channel between the first wireless station and the first wireless node; and the second composite channel matrix is based on a second channel matrix for the second channel between the second wireless station and the second wireless node and a fourth channel matrix for a fourth channel between the second wireless station and the first wireless node.

In some aspects, the method 1600 further includes reconstructing, based on the information regarding the first matrix and the second matrix, a first equivalent channel between the second wireless node and the first wireless station. In some cases, the operations of this step refer to, or may be performed by, circuitry for reconstructing and/or code for reconstructing as described with reference to FIG. 21.

In some aspects, the method 1600 further includes reconstructing, based on the information regarding the third matrix and the fourth matrix, a second equivalent channel between the second wireless node and the second wireless station. In some cases, the operations of this step refer to, or may be performed by, circuitry for reconstructing and/or code for reconstructing as described with reference to FIG. 21.

In some aspects, the method 1600 further includes reconstructing a third composite channel matrix based on the reconstructed first equivalent channel and the reconstructed second equivalent channel. In some cases, the operations of this step refer to, or may be performed by, circuitry for reconstructing and/or code for reconstructing as described with reference to FIG. 21.

In some aspects, compressing the CSI feedback comprises performing an SVD of the reconstructed third composite channel matrix.

In some aspects, the compressed CSI feedback comprises information regarding a fifth matrix and a sixth matrix generated by the SVD of the reconstructed third composite channel matrix, wherein the fifth matrix comprises a diagonal real matrix and the sixth matrix comprises a right semi-unitary or a unitary matrix.

In one aspect, method 1600, or any aspect related to it, may be performed by an apparatus, such as communications device 2100 of FIG. 21, which includes various components operable, configured, or adapted to perform the method 1600. Communications device 2100 is described below in further detail.

Note that FIG. 16 is just one example of a method, and other methods including fewer, additional, or alternative steps are possible consistent with this disclosure.

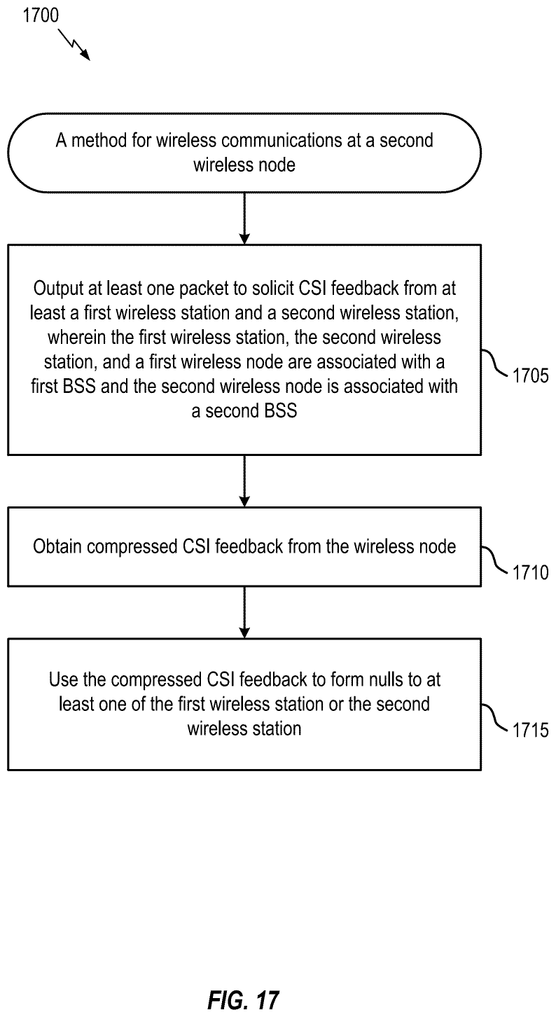

FIG. 17 shows an example of a process or method 1700 of wireless communication performable by or at a second wireless node. The operations of the process 1700 may be implemented by a wireless node or its components as described herein. For example, the process 1700 may be performed by a wireless communication device, such as the wireless communication device 2100 described with reference to FIG. 21, operating as or within a wireless node.

Method 1700 begins at step 1705 with outputting at least one packet to solicit CSI feedback from at least a first wireless station and a second wireless station, wherein the first wireless station, the second wireless station, and a first wireless node are associated with a first BSS and the second wireless node is associated with a second BSS. In some cases, the operations of this step refer to, or may be performed by, circuitry for outputting and/or code for outputting as described with reference to FIG. 21.

Method 1700 then proceeds to step 1710 with obtaining compressed CSI feedback from the wireless node. In some cases, the operations of this step refer to, or may be performed by, circuitry for obtaining and/or code for obtaining as described with reference to FIG. 21.

Method 1700 then proceeds to step 1715 with using the compressed CSI feedback to form nulls to at least one of the first wireless station or the second wireless station. In some cases, the operations of this step refer to, or may be performed by, circuitry for using and/or code for using as described with reference to FIG. 21.

In some aspects, the first CSI feedback for the first channel comprises information regarding a first matrix and a second matrix, wherein the first matrix and the second matrix are based on a SVD of an equivalent first channel matrix; and the second CSI feedback for the second channel comprises information regarding a third matrix and a fourth matrix, wherein the third matrix and the fourth matrix are based on an SVD of an equivalent second channel matrix.

In some aspects, the first matrix comprises a diagonal real matrix and the second matrix comprises a right semi-unitary or a unitary matrix; and the third matrix comprises a diagonal real matrix and the fourth matrix comprises a right semi-unitary or a unitary matrix.

In some aspects, the compressed CSI feedback comprises information regarding a fifth matrix and a sixth matrix generated by an SVD of a composite matrix, wherein the fifth matrix comprises a diagonal real matrix and the sixth matrix comprises a right semi-unitary or a unitary matrix.

In some aspects, the first CSI feedback for the first channel comprises information regarding a first matrix and a second matrix, wherein the first matrix and the second matrix are based on a SVD of a first composite channel matrix; and the second CSI feedback for the second channel comprises information regarding a third matrix and a fourth matrix, wherein the third matrix and the fourth matrix are based on an SVD of a second composite channel matrix.

In some aspects, the first matrix comprises a diagonal real matrix and the second matrix comprises a right semi-unitary or a unitary matrix; and the third matrix comprises a diagonal real matrix and the fourth matrix comprises a right semi-unitary or a unitary matrix.

In some aspects, the first composite channel matrix is based on a first channel matrix for the first channel between the first wireless station and the second wireless node and a third channel matrix for a third channel between the first wireless station and the first wireless node; and the second composite channel matrix is based on a second channel matrix for the second channel between the second wireless station and the second wireless node and a fourth channel matrix for a fourth channel between the second wireless station and the first wireless node.

In some aspects, the compressed CSI feedback comprises information regarding a fifth matrix and a sixth matrix generated by an SVD of a reconstructed composite channel matrix, wherein the fifth matrix comprises a diagonal real matrix and the sixth matrix comprises a right semi-unitary or a unitary matrix.

In one aspect, method 1700, or any aspect related to it, may be performed by an apparatus, such as communications device 2100 of FIG. 21, which includes various components operable, configured, or adapted to perform the method 1700. Communications device 2100 is described below in further detail.

Note that FIG. 17 is just one example of a method, and other methods including fewer, additional, or alternative steps are possible consistent with this disclosure.

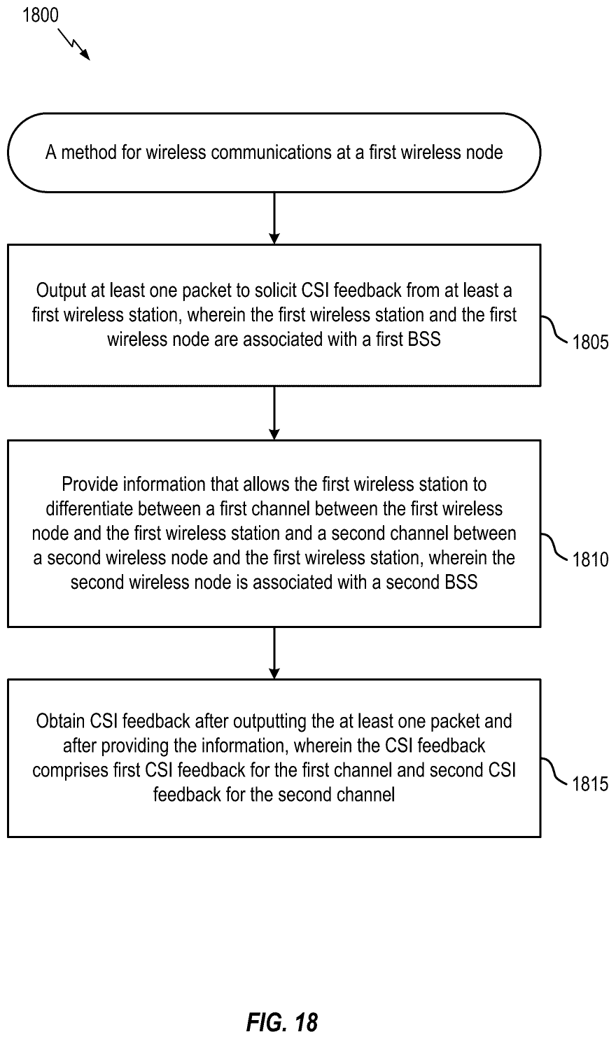

FIG. 18 shows an example of a process or method 1800 of wireless communication performable by or at a first wireless node. The operations of the process 1800 may be implemented by a wireless node or its components as described herein. For example, the process 1800 may be performed by a wireless communication device, such as the wireless communication device 2100 described with reference to FIG. 21, operating as or within a wireless node.

Method 1800 begins at step 1805 with outputting at least one packet to solicit CSI feedback from at least a first wireless station, wherein the first wireless station and the first wireless node are associated with a first BSS. In some cases, the operations of this step refer to, or may be performed by, circuitry for outputting and/or code for outputting as described with reference to FIG. 21.

Method 1800 then proceeds to step 1810 with providing information that allows the first wireless station to differentiate between a first channel between the first wireless node and the first wireless station and a second channel between a second wireless node and the first wireless station, wherein the second wireless node is associated with a second BSS. In some cases, the operations of this step refer to, or may be performed by, circuitry for providing and/or code for providing as described with reference to FIG. 21.

Method 1800 then proceeds to step 1815 with obtaining CSI feedback after outputting the at least one packet and after providing the information, wherein the CSI feedback comprises first CSI feedback for the first channel and second CSI feedback for the second channel. In some cases, the operations of this step refer to, or may be performed by, circuitry for obtaining and/or code for obtaining as described with reference to FIG. 21.

In some aspects, the at least one packet comprises at least one NDP.

In some aspects, the information is provided via the at least one NDP.

In some aspects, the at least one NDP comprises a joint NDP output in coordination with the second wireless node, wherein the joint NDP has: one or more fields with information from the first wireless node and the second wireless node; and at least one training field with a first subset of one or multiple spatial streams from the first wireless node and a second subset of one or multiple spatial streams from the second wireless node.

In some aspects, the information comprises a bitmap field with bits, wherein each bit indicates: via a first bit value, that a corresponding spatial stream is from an interfering wireless node; or via a second bit value, that the corresponding spatial stream is from a wireless node associated with the first wireless station.

In some aspects, the information indicates the first subset and the second subset.

In some aspects, the information indicates a quantity of wireless nodes coordinating for the joint NDP.

In some aspects, the information further indicates a quantity of spatial streams for each of the wireless nodes coordinating for the joint NDP.

In some aspects, the information identifies a group of one or more BSS IDs associated with the wireless nodes coordinating for the joint NDP.

In some aspects, the information comprises a bitmap field with bits, wherein each bit indicates: via a first bit value, that a corresponding wireless node is an interfering wireless node; or via a second bit value, that the corresponding wireless node is associated with the first wireless station.

In some aspects, the information indicates a common BSS ID for both the first wireless node and the second wireless node to use when outputting the joint NDP.

In some aspects, the at least one NDP comprise a first NDP output sequentially before or after a second NDP output from the second wireless node.

In some aspects, the information identifies a BSS color used for each of the first NDP and the second NDP.

In some aspects, the information indicates: via a first bit value, that a corresponding wireless node is associated with the first wireless station; or via a second bit value, that the corresponding wireless node is an interfering wireless node.

In some aspects, the information is provided via a NDPA frame.

In one aspect, method 1800, or any aspect related to it, may be performed by an apparatus, such as communications device 2100 of FIG. 21, which includes various components operable, configured, or adapted to perform the method 1800. Communications device 2100 is described below in further detail.

Note that FIG. 18 is just one example of a method, and other methods including fewer, additional, or alternative steps are possible consistent with this disclosure.

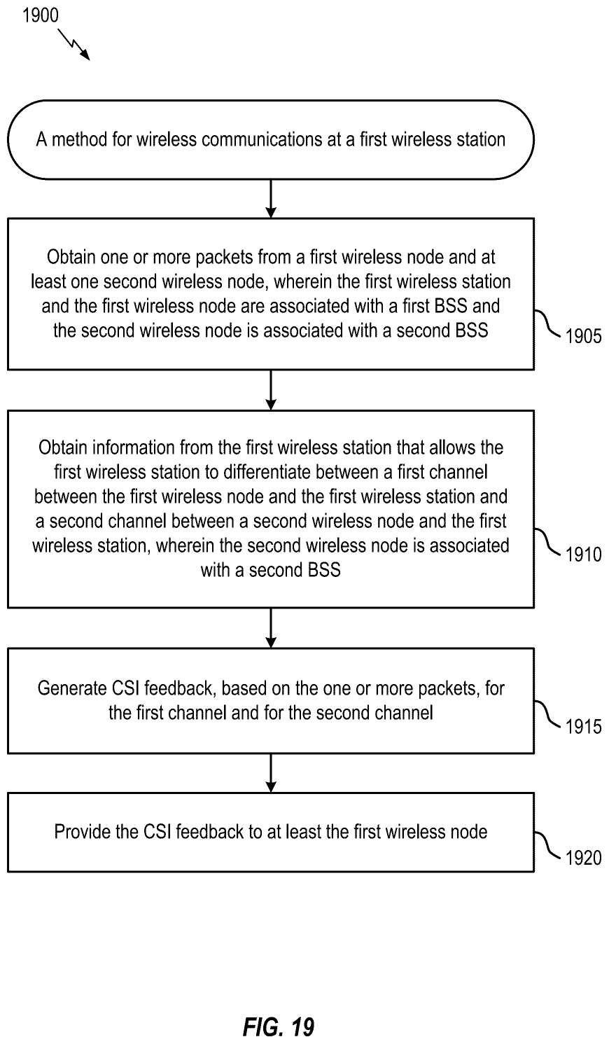

FIG. 19 shows an example of a process or method 1900 of wireless communication performable by or at a first wireless station. The operations of the process 1900 may be implemented by a wireless node or its components as described herein. For example, the process 1900 may be performed by a wireless communication device, such as the wireless communication device 2100 described with reference to FIG. 21, operating as or within a wireless node.

Method 1900 begins at step 1905 with obtaining one or more packets from a first wireless node and at least one second wireless node, wherein the first wireless station and the first wireless node are associated with a first BSS and the second wireless node is associated with a second BSS. In some cases, the operations of this step refer to, or may be performed by, circuitry for obtaining and/or code for obtaining as described with reference to FIG. 21.

Method 1900 then proceeds to step 1910 with obtaining information from the first wireless station that allows the first wireless station to differentiate between a first channel between the first wireless node and the first wireless station and a second channel between a second wireless node and the first wireless station, wherein the second wireless node is associated with a second BSS. In some cases, the operations of this step refer to, or may be performed by, circuitry for obtaining and/or code for obtaining as described with reference to FIG. 21.

Method 1900 then proceeds to step 1915 with generating CSI feedback, based on the one or more packets, for the first channel and for the second channel. In some cases, the operations of this step refer to, or may be performed by, circuitry for generating and/or code for generating as described with reference to FIG. 21.

Method 1900 then proceeds to step 1920 with providing the CSI feedback to at least the first wireless node. In some cases, the operations of this step refer to, or may be performed by, circuitry for providing and/or code for providing as described with reference to FIG. 21.

In some aspects, the one or more packets comprise at least one NDP.

In some aspects, the information is obtained via the at least one NDP.

In some aspects, the at least one NDP comprises a joint NDP output in coordination with the second wireless node, wherein the joint NDP has: one or more fields with information from the first wireless node and the second wireless node; and at least one training field with a first subset of one or multiple spatial streams from the first wireless node and a second subset of one or multiple spatial streams from the second wireless node.

In some aspects, the information comprises a bitmap field with bits, wherein each bit indicates: via a first bit value, that a corresponding spatial stream is from an interfering wireless node; or via a second bit value, that the corresponding spatial stream is from a wireless node associated with the first wireless station.

In some aspects, the information indicates the first subset and the second subset.

In some aspects, the information indicates a quantity of wireless nodes coordinating for the joint NDP.

In some aspects, the information further indicates a quantity of spatial streams for each of the wireless nodes coordinating for the joint NDP.

In some aspects, the information identifies a group of one or more BSS IDs associated with the wireless nodes coordinating for the joint NDP.

In some aspects, the information comprises a bitmap field with bits, wherein each bit indicates: via a first bit value, that a corresponding wireless node is an interfering wireless node; or via a second bit value, that the corresponding wireless node is associated with the first wireless station.

In some aspects, the information indicates a common BSS ID for both the first wireless node and the second wireless node to use when outputting the joint NDP.

In some aspects, the at least one NDP comprise a first NDP output sequentially before or after a second NDP output from the second wireless node.

In some aspects, the information identifies a BSS color used for each of the first NDP and the second NDP.

In some aspects, the information indicates: via a first bit value, that a corresponding wireless node is associated with the first wireless station; or via a second bit value, that the corresponding wireless node is an interfering wireless node.

In some aspects, the information is obtained via a NDPA frame.

In one aspect, method 1900, or any aspect related to it, may be performed by an apparatus, such as communications device 2100 of FIG. 21, which includes various components operable, configured, or adapted to perform the method 1900. Communications device 2100 is described below in further detail.

Note that FIG. 19 is just one example of a method, and other methods including fewer, additional, or alternative steps are possible consistent with this disclosure.

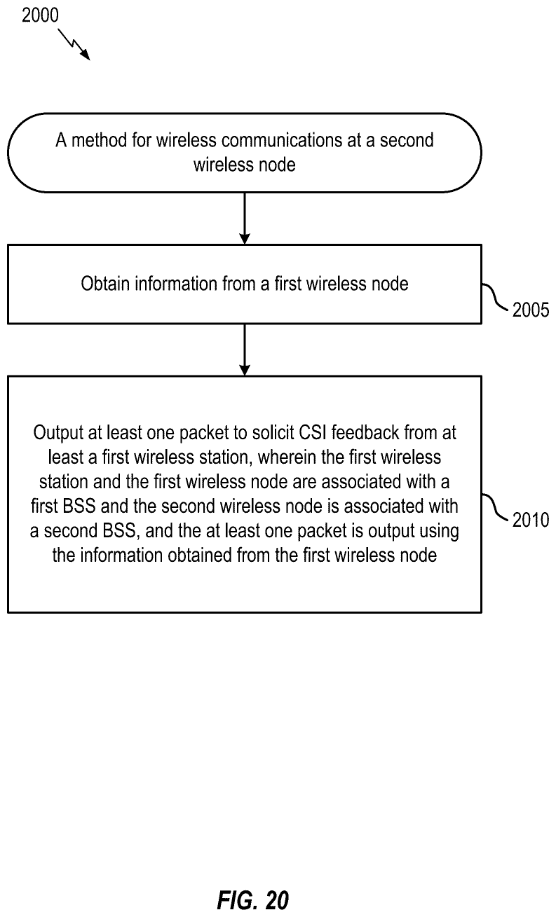

FIG. 20 shows an example of a process or method 2000 of wireless communication performable by or at a second wireless node. The operations of the process 2000 may be implemented by a wireless node or its components as described herein. For example, the process 2000 may be performed by a wireless communication device, such as the wireless communication device 2100 described with reference to FIG. 21, operating as or within a wireless node.

Method 2000 begins at step 2005 with obtaining information from a first wireless node. In some cases, the operations of this step refer to, or may be performed by, circuitry for obtaining and/or code for obtaining as described with reference to FIG. 21.

Method 2000 then proceeds to step 2010 with outputting at least one packet to solicit CSI feedback from at least a first wireless station, wherein the first wireless station and the first wireless node are associated with a first BSS and the second wireless node is associated with a second BSS, and the at least one packet is output using the information obtained from the first wireless node. In some cases, the operations of this step refer to, or may be performed by, circuitry for outputting and/or code for outputting as described with reference to FIG. 21.

In some aspects, the at least one packet comprises at least one NDP.

In some aspects, the at least one NDP comprises a joint NDP output in coordination with the first wireless node, wherein the joint NDP has: one or more fields with information from the first wireless node and the second wireless node; and at least one training field with a first subset of one or multiple spatial streams from the first wireless node and a second subset of one or multiple spatial streams from the second wireless node.

In some aspects, the information indicates the first subset and the second subset.

In some aspects, the information indicates a common BSS ID for both the first wireless node and the second wireless node to use when outputting the joint NDP.

In some aspects, the information further indicates a quantity of spatial streams for each of the wireless nodes coordinating for the joint NDP.

In some aspects, the information identifies a group of one or more BSS IDs associated with the wireless nodes coordinating for the joint NDP, wherein the group of one or more BSS IDs includes a BSS ID for the second BSS.

In some aspects, the at least one NDP comprise a first NDP output sequentially before or after a second NDP output from the first wireless node.

In some aspects, the information identifies a BSS color used for each of the first NDP and the second NDP.

In one aspect, method 2000, or any aspect related to it, may be performed by an apparatus, such as communications device 2100 of FIG. 21, which includes various components operable, configured, or adapted to perform the method 2000. Communications device 2100 is described below in further detail.

Note that FIG. 20 is just one example of a method, and other methods including fewer, additional, or alternative steps are possible consistent with this disclosure.

FIG. 21 shows a block diagram of a wireless communication device or wireless node 2100 (e.g., an AP, a non-AP STA, a non-AP MLD, a STA), according to some aspects of the present disclosure. For example, the wireless communication device 2100 may be configured or operable to perform one or more of the processes 1400-2000 described with reference to FIGS. 14-20.

The wireless communication device 2100 may include one or more chips, SoCs, chipsets, packages, components or devices that individually or collectively constitute or comprise a processing system. The processing system may interface with other components of the wireless communication device 2100, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the device 2100 may transmit the information output from the chip. In such an example, the second interface may refer to an interface between the processing system of the chip and a reception component, such that the device 2100 may receive information that is then passed to the processing system. In some such examples, the first interface also may obtain information, such as from the transmission component, and the second interface also may output information, such as to the reception component.

The processing system of the wireless communication device 2100 includes processor (or “processing”) circuitry in the form of one or multiple processors, microprocessors, processing units (such as central processing units (CPUs), graphics processing units (GPUs) or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 2100 can be a device for use in an AP or an AP MLD, such as AP 102 described with reference to FIG. 1. In some other examples, the wireless communication device 2100 can be an AP that includes such a processing system and other components including multiple antennas. The wireless communication device 2100 is capable of transmitting and receiving wireless communications in the form of, for example, wireless packets. For example, the wireless communication device 2100 can be configurable or configured to transmit and receive packets in the form of physical layer PPDUs and MPDUs conforming to one or more of the IEEE 802.11 family of wireless communication protocol standards. In some other examples, the wireless communication device 2100 can be configurable or configured to transmit and receive signals and communications conforming to one or more 3GPP specifications including those for 5G NR or 6G. In some examples, the wireless communication device 2100 also includes or can be coupled with one or more application processors which may be further coupled with one or more other memories. In some examples, the wireless communication device 2100 further includes at least one external network interface coupled with the processing system that enables communication with a core network or backhaul network that enables the wireless communication device 2100 to gain access to external networks including the Internet.

In some examples, the wireless communication device 2100 can be a device for use in a STA or a non-AP STA, such as STA 104 described with reference to FIG. 1. In some examples, the wireless communication device 2100 further includes a user interface (UI) (such as a touchscreen or keypad) and a display, which may be integrated with the UI to form a touchscreen display. In some examples, the wireless communication device 2100 may further include one or more sensors such as, for example, one or more inertial sensors, accelerometers, temperature sensors, pressure sensors, or altitude sensors.

The wireless communication device 2100 includes obtaining component 2102, outputting/providing component 2104, generating component 2106, computing component 2108, compressing component 2110, and/or decompressing compressing component 2112. Portions of one or more of the components 2102-2112 may be implemented at least in part in hardware or firmware. For example, the obtaining component 2102 and the outputting component 2104 may be implemented at least in part by a modem. In some examples, at least some of the components such as 2102, 2104, 2106, 2108, 2110, and/or 2112 are implemented at least in part by at least one processor and as software stored in a memory. For example, portions of one or more of the components 2102, 2104, 2106, 2108, 2110, and/or 2112 can be implemented as non-transitory instructions (or “code”) executable by the processor to perform the functions or operations of the respective module.

Various components of the wireless communication device 2100 may provide means for performing one or more of the processes 1400-2000 described with reference to FIGS. 14-20, or any aspect related to them. Means for receiving or obtaining may include transceivers and/or antenna(s) of the AP 102 (or the STA 104) described with reference to FIG. 1 and/or the obtaining component 2102 of the wireless communication device 2100. Means for transmitting, sending or outputting (e.g., for transmission) may include transceivers and/or antenna(s) of the AP 102 (or the STA 104) described with reference to FIG. 1 and/or the outputting component 2104 of the wireless communication device 2100.

In some cases, rather than actually transmitting, for example, signals and/or data, the wireless communication device 2100 may have an interface to output or provide signals and/or data for transmission (means for outputting or means for providing). For example, a processor may output signals and/or data, via a bus interface, to a radio frequency (RF) front end of the wireless communication device 2100 for transmission. In various aspects, the RF front end may include various components, including transmit and receive processors, transmit and receive MIMO processors, modulators, demodulators, and the like.

In some cases, rather than actually receiving signals and/or data, the wireless communication device 2100 may have an interface to obtain the signals and/or data received from another device (means for obtaining). For example, a processor may obtain (or receive) the signals and/or data, via a bus interface, from an RF front end of the wireless communication device 2100 for reception. In various aspects, the RF front end may include various components, including transmit and receive processors, transmit and receive MIMO processors, modulators, demodulators, and the like. In various aspects, means for computing, means for generating, means for outputting, and means for obtaining, means for providing, means for compressing, means for using, means for performing, means for reconstructing, means for decompressing, means for transmitting, and/or means for receiving may comprise one or more processors (such as the one or more processors/components illustrated in the figures and/or described above).

### Example Clauses

Implementation examples are described in the following numbered clauses.

Clause 1: A method for wireless communications at a first wireless node, comprising: outputting at least one packet to solicit CSI feedback from at least a first wireless station and a second wireless station, wherein the first wireless station, the second wireless station, and the first wireless node are associated with a first BSS; obtaining CSI feedback after outputting the at least one packet, wherein the CSI feedback comprises first CSI feedback for a first channel between the first wireless station and a second wireless node and second CSI feedback for a second channel between the second wireless station and the second wireless node, wherein the second wireless node is associated with a second BSS; compressing the CSI feedback; and providing the compressed CSI feedback to the second wireless node.

Clause 2: The method of Clause 1, further comprising: providing, to the first wireless station and the second wireless station, signaling indicating a requested rank for the CSI feedback, wherein the obtained CSI feedback is of the requested rank.

Clause 3: The method of any one of Clauses 1-2, wherein: the first CSI feedback for the first channel comprises information regarding a first matrix and a second matrix, wherein the first matrix and the second matrix are based on a SVD of an equivalent first channel matrix; and the second CSI feedback for the second channel comprises information regarding a third matrix and a fourth matrix, wherein the third matrix and the fourth matrix are based on an SVD of an equivalent second channel matrix.

Clause 4: The method of Clause 3, wherein: the first matrix comprises a diagonal real matrix and the second matrix comprises a right semi-unitary or a unitary matrix; and the third matrix comprises a diagonal real matrix and the fourth matrix comprises a right semi-unitary or a unitary matrix.

Clause 5: The method of Clause 3, further comprising: reconstructing a composite channel based on the information regarding the first matrix, the second matrix, the third matrix, and the fourth matrix.

Clause 6: The method of Clause 5, wherein compressing the CSI feedback comprises performing an SVD of a composite channel matrix for the reconstructed composite channel.

Clause 7: The method of Clause 6, wherein the compressed CSI feedback comprises information regarding a fifth matrix and a sixth matrix generated by the SVD of the composite matrix, wherein the fifth matrix comprises a diagonal real matrix and the sixth matrix comprises a right semi-unitary or a unitary matrix.

Clause 8: The method of any one of Clauses 1-7, wherein: the first CSI feedback for the first channel comprises information regarding a first matrix and a second matrix, wherein the first matrix and the second matrix are based on a SVD of a first composite channel matrix; and the second CSI feedback for the second channel comprises information regarding a third matrix and a fourth matrix, wherein the third matrix and the fourth matrix are based on an SVD of a second composite channel matrix.

Clause 9: The method of Clause 8, wherein: the first matrix comprises a diagonal real matrix and the second matrix comprises a right semi-unitary or a unitary matrix; and the third matrix comprises a diagonal real matrix and the fourth matrix comprises a right semi-unitary or a unitary matrix.

Clause 10: The method of Clause 8, wherein: the first composite channel matrix is based on a first channel matrix for the first channel between the first wireless station and the second wireless node and a third channel matrix for a third channel between the first wireless station and the first wireless node; and the second composite channel matrix is based on a second channel matrix for the second channel between the second wireless station and the second wireless node and a fourth channel matrix for a fourth channel between the second wireless station and the first wireless node.

Clause 11: The method of Clause 8, further comprising: reconstructing, based on the information regarding the first matrix and the second matrix, a first equivalent channel between the second wireless node and the first wireless station; reconstructing, based on the information regarding the third matrix and the fourth matrix, a second equivalent channel between the second wireless node and the second wireless station; and reconstructing a third composite channel matrix based on the reconstructed first equivalent channel and the reconstructed second equivalent channel.

Clause 12: The method of Clause 11, wherein compressing the CSI feedback comprises performing an SVD of the reconstructed third composite channel matrix.

Clause 13: The method of Clause 12, wherein the compressed CSI feedback comprises information regarding a fifth matrix and a sixth matrix generated by the SVD of the reconstructed third composite channel matrix, wherein the fifth matrix comprises a diagonal real matrix and the sixth matrix comprises a right semi-unitary or a unitary matrix.

Clause 14: A method for wireless communications at a second wireless node, comprising: outputting at least one packet to solicit CSI feedback from at least a first wireless station and a second wireless station, wherein the first wireless station, the second wireless station, and a first wireless node are associated with a first BSS and the second wireless node is associated with a second BSS; obtaining compressed CSI feedback from the wireless node; and using the compressed CSI feedback to form nulls to at least one of the first wireless station or the second wireless station.

Clause 15: The method of Clause 14, wherein: the first CSI feedback for the first channel comprises information regarding a first matrix and a second matrix, wherein the first matrix and the second matrix are based on a SVD of an equivalent first channel matrix; and the second CSI feedback for the second channel comprises information regarding a third matrix and a fourth matrix, wherein the third matrix and the fourth matrix are based on an SVD of an equivalent second channel matrix.

Clause 16: The method of Clause 15, wherein: the first matrix comprises a diagonal real matrix and the second matrix comprises a right semi-unitary or a unitary matrix; and the third matrix comprises a diagonal real matrix and the fourth matrix comprises a right semi-unitary or a unitary matrix.

Clause 17: The method of Clause 16, wherein the compressed CSI feedback comprises information regarding a fifth matrix and a sixth matrix generated by an SVD of a composite matrix, wherein the fifth matrix comprises a diagonal real matrix and the sixth matrix comprises a right semi-unitary or a unitary matrix.

Clause 18: The method of any one of Clauses 14-17, wherein: the first CSI feedback for the first channel comprises information regarding a first matrix and a second matrix, wherein the first matrix and the second matrix are based on a SVD of a first composite channel matrix; and the second CSI feedback for the second channel comprises information regarding a third matrix and a fourth matrix, wherein the third matrix and the fourth matrix are based on an SVD of a second composite channel matrix.

Clause 19: The method of Clause 18, wherein: the first matrix comprises a diagonal real matrix and the second matrix comprises a right semi-unitary or a unitary matrix; and the third matrix comprises a diagonal real matrix and the fourth matrix comprises a right semi-unitary or a unitary matrix.

Clause 20: The method of Clause 18, wherein: the first composite channel matrix is based on a first channel matrix for the first channel between the first wireless station and the second wireless node and a third channel matrix for a third channel between the first wireless station and the first wireless node; and the second composite channel matrix is based on a second channel matrix for the second channel between the second wireless station and the second wireless node and a fourth channel matrix for a fourth channel between the second wireless station and the first wireless node.

Clause 21: The method of Clause 18, wherein the compressed CSI feedback comprises information regarding a fifth matrix and a sixth matrix generated by an SVD of a reconstructed composite channel matrix, wherein the fifth matrix comprises a diagonal real matrix and the sixth matrix comprises a right semi-unitary or a unitary matrix.

Clause 22: A method for wireless communications at a first wireless node, comprising: outputting at least one packet to solicit CSI feedback from at least a first wireless station, wherein the first wireless station and the first wireless node are associated with a first BSS; providing information that allows the first wireless station to differentiate between a first channel between the first wireless node and the first wireless station and a second channel between a second wireless node and the first wireless station, wherein the second wireless node is associated with a second BSS; and obtaining CSI feedback after outputting the at least one packet and after providing the information, wherein the CSI feedback comprises first CSI feedback for the first channel and second CSI feedback for the second channel.

Clause 23: The method of Clause 22, wherein the at least one packet comprises at least one NDP.

Clause 24: The method of Clause 23, wherein the information is provided via the at least one NDP.

Clause 25: The method of any one of Clauses 22-24, wherein the information is provided via a NDPA frame.

Clause 26: The method of Clause 23, wherein the at least one NDP comprises a joint NDP output in coordination with the second wireless node, wherein the joint NDP has: one or more fields with information from the first wireless node and the second wireless node; and at least one training field with a first subset of one or multiple spatial streams from the first wireless node and a second subset of one or multiple spatial streams from the second wireless node.

Clause 27: The method of Clause 26, wherein the information comprises a bitmap field with bits, wherein each bit indicates: via a first bit value, that a corresponding spatial stream is from an interfering wireless node; or via a second bit value, that the corresponding spatial stream is from a wireless node associated with the first wireless station.

Clause 28: The method of Clause 26, wherein the information indicates the first subset and the second subset.

Clause 29: The method of Clause 26, wherein the information indicates a quantity of wireless nodes coordinating for the joint NDP.

Clause 30: The method of Clause 26, wherein the information indicates a common BSS ID for both the first wireless node and the second wireless node to use when outputting the joint NDP.

Clause 31: The method of Clause 29, wherein the information further indicates a quantity of spatial streams for each of the wireless nodes coordinating for the joint NDP.

Clause 32: The method of Clause 29, wherein the information identifies a group of one or more BSS IDs associated with the wireless nodes coordinating for the joint NDP.

Clause 33: The method of Clause 29, wherein the information comprises a bitmap field with bits, wherein each bit indicates: via a first bit value, that a corresponding wireless node is an interfering wireless node; or via a second bit value, that the corresponding wireless node is associated with the first wireless station.

Clause 34: The method of Clause 23, wherein the at least one NDP comprise a first NDP output sequentially before or after a second NDP output from the second wireless node.

Clause 35: The method of Clause 34, wherein the information identifies a BSS color used for each of the first NDP and the second NDP.

Clause 36: The method of Clause 34, wherein the information indicates: via a first bit value, that a corresponding wireless node is associated with the first wireless station; or via a second bit value, that the corresponding wireless node is an interfering wireless node.

Clause 37: A method for wireless communications at a first wireless station, comprising: obtaining one or more packets from a first wireless node and at least one second wireless node, wherein the first wireless station and the first wireless node are associated with a first BSS and the second wireless node is associated with a second BSS; obtaining information from the first wireless station that allows the first wireless station to differentiate between a first channel between the first wireless node and the first wireless station and a second channel between a second wireless node and the first wireless station, wherein the second wireless node is associated with a second BSS; generating CSI feedback, based on the one or more packets, for the first channel and for the second channel; and providing the CSI feedback to at least the first wireless node.

Clause 38: The method of Clause 37, wherein the one or more packets comprise at least one NDP.

Clause 39: The method of Clause 38, wherein the information is obtained via the at least one NDP.

Clause 40: The method of any one of Clauses 37-39, wherein the information is obtained via a NDPA frame.

Clause 41: The method of Clause 38, wherein the at least one NDP comprises a joint NDP output in coordination with the second wireless node, wherein the joint NDP has: one or more fields with information from the first wireless node and the second wireless node; and at least one training field with a first subset of one or multiple spatial streams from the first wireless node and a second subset of one or multiple spatial streams from the second wireless node.

Clause 42: The method of Clause 41, wherein the information comprises a bitmap field with bits, wherein each bit indicates: via a first bit value, that a corresponding spatial stream is from an interfering wireless node; or via a second bit value, that the corresponding spatial stream is from a wireless node associated with the first wireless station.

Clause 43: The method of Clause 41, wherein the information indicates the first subset and the second subset.

Clause 44: The method of Clause 41, wherein the information indicates a quantity of wireless nodes coordinating for the joint NDP.

Clause 45: The method of Clause 41, wherein the information indicates a common BSS ID for both the first wireless node and the second wireless node to use when outputting the joint NDP.

Clause 46: The method of Clause 44, wherein the information further indicates a quantity of spatial streams for each of the wireless nodes coordinating for the joint NDP.

Clause 47: The method of Clause 44, wherein the information identifies a group of one or more BSS IDs associated with the wireless nodes coordinating for the joint NDP.

Clause 48: The method of Clause 44, wherein the information comprises a bitmap field with bits, wherein each bit indicates: via a first bit value, that a corresponding wireless node is an interfering wireless node; or via a second bit value, that the corresponding wireless node is associated with the first wireless station.

Clause 49: The method of Clause 38, wherein the at least one NDP comprise a first NDP output sequentially before or after a second NDP output from the second wireless node.

Clause 50: The method of Clause 49, wherein the information identifies a BSS color used for each of the first NDP and the second NDP.

Clause 51: The method of Clause 49, wherein the information indicates: via a first bit value, that a corresponding wireless node is associated with the first wireless station; or via a second bit value, that the corresponding wireless node is an interfering wireless node.

Clause 52: A method for wireless communications at a second wireless node, comprising: obtaining information from a first wireless node; and outputting at least one packet to solicit CSI feedback from at least a first wireless station, wherein the first wireless station and the first wireless node are associated with a first BSS and the second wireless node is associated with a second BSS, and the at least one packet is output using the information obtained from the first wireless node.

Clause 53: The method of Clause 52, wherein the at least one packet comprises at least one NDP.

Clause 54: The method of Clause 53, wherein the at least one NDP comprises a joint NDP output in coordination with the first wireless node, wherein the joint NDP has: one or more fields with information from the first wireless node and the second wireless node; and at least one training field with a first subset of one or multiple spatial streams from the first wireless node and a second subset of one or multiple spatial streams from the second wireless node.

Clause 55: The method of Clause 54, wherein the information indicates the first subset and the second subset.

Clause 56: The method of Clause 54, wherein the information indicates a common BSS ID for both the first wireless node and the second wireless node to use when outputting the joint NDP.

Clause 57: The method of Clause 56, wherein the information further indicates a quantity of spatial streams for each of the wireless nodes coordinating for the joint NDP.

Clause 58: The method of Clause 56, wherein the information identifies a group of one or more BSS IDs associated with the wireless nodes coordinating for the joint NDP, wherein the group of one or more BSS IDs includes a BSS ID for the second BSS.

Clause 59: The method of Clause 53, wherein the at least one NDP comprise a first NDP output sequentially before or after a second NDP output from the first wireless node.

Clause 60: The method of Clause 59, wherein the information identifies a BSS color used for each of the first NDP and the second NDP.

Clause 61: A method for wireless communications at a third wireless node, comprising: obtaining one or more packets from a first wireless node and at least one second wireless node, wherein third wireless node and the first wireless node are associated with a first basic service set (BSS) and the second wireless node is associated with a second BSS; generating CSI feedback, based on the one or more packets, for a first channel between third wireless node and the first wireless node and for a second channel between third wireless node and the second wireless node; and providing the CSI feedback to at least the first wireless node.

Clause 62: The method of Clause 61, wherein the CSI feedback is also provided directly from third wireless node to the second wireless node.

Clause 63: The method of any one of Clauses 61-62, further comprising: obtaining signaling indicating a requested rank for the CSI feedback, wherein the provided CSI feedback is of the requested rank.

Clause 64: The method of any one of Clauses 61-63, wherein the one or more packets comprise first and second packets obtained sequentially from the first wireless node and second wireless node.

Clause 65: The method of any one of Clauses 61-64, wherein generating the CSI feedback comprises: performing a singular value decomposition (SVD) of an original channel matrix for the first channel to obtain a first matrix that is a left semi-unitary or a unitary matrix, a second matrix that is a diagonal real matrix, and a third matrix that is a right semi-unitary or a unitary matrix, wherein the CSI feedback for the first channel is based on the second matrix and the third matrix; and performing an SVD of an equivalent channel matrix for the second channel to obtain a fourth matrix that is a left semi-unitary or a unitary matrix, a fifth matrix that is a diagonal real matrix, and a sixth matrix that is a right semi-unitary or a unitary matrix, wherein the CSI feedback for the second channel is based on the fifth matrix and the sixth matrix.

Clause 66: The method of Clause 65, wherein the equivalent channel matrix for the second channel assumes a same linear receiver associated with processing the original channel matrix for the first channel.

Clause 67: The method of Clause 66, wherein the linear receiver is formed by one or more dominant left-singular vectors of the original channel matrix for the first channel.

Clause 68: The method of any one of Clauses 61-67, wherein the CSI feedback comprises: performing a singular value decomposition (SVD) of a first channel matrix for the first channel to obtain a first matrix that is a left semi-unitary or a unitary matrix, a second matrix that is a diagonal real matrix, and a third matrix that is a right semi-unitary or a unitary matrix, wherein the CSI feedback for the first channel is based on the first matrix, the second matrix, and the third matrix; and performing an SVD of a second channel matrix for the second channel to obtain a fourth matrix that is a left semi-unitary or a unitary matrix, a fifth matrix that is a diagonal real matrix, and a sixth matrix that is a right semi-unitary or a unitary matrix, wherein the CSI feedback for the second channel is based on the fourth matrix, the fifth matrix, and the sixth matrix.

Clause 69: The method of any one of Clauses 61-68, wherein: the one or more packets comprise one or more null data packets (NDPs) obtained from the first and second wireless nodes; and generating the CSI feedback comprises: generating a composite channel matrix, based on the one or more NDPs, and performing a singular value decomposition (SVD) of the composite channel matrix to obtain a first matrix that is a left semi-unitary or unitary matrix, a second matrix that is a diagonal real matrix, and a third matrix that is a right semi-unitary or unitary matrix, wherein the CSI feedback is based on at least the second matrix and the third matrix.

Clause 70: The method of Clause 69, wherein the composite channel matrix is generated based on: a first channel matrix for the first channel between third wireless node and the first wireless node; and a second channel matrix for the second channel between third wireless node and the second wireless node.

Clause 71: The method of Clause 69, wherein the one or more NDPs comprise a joint NDP that has: one or more fields with same information from both the first and second wireless nodes; and at least one training field with a first subset of one or multiple spatial streams from the first wireless node and a second subset of one or multiple spatial streams from the second wireless node.

Clause 72: The method of Clause 71, further comprising obtaining information indicating the first subset and the second subset.

Clause 73: The method of Clause 72, wherein: the information is obtained via a NDP announcement (NDPA) frame, or the one or more NDPs.

Clause 74: The method of Clause 71, wherein the information comprises at least one of: a quantity of transmit antennas used by each of the first and second wireless nodes; or a quantity of streams from each of the first and second wireless nodes.

Clause 75: A method for wireless communications at a first wireless node, comprising: outputting at least one packet to solicit channel state information (CSI) feedback from at least a first wireless station, wherein the first wireless station and the first wireless node are associated with a first basic service set (BSS); obtaining CSI feedback, after outputting the at least one packet, for a first channel between the first wireless station and the first wireless node and for a second channel between the first wireless station and a second wireless node, wherein the second wireless node is associated with a second BSS; computing precoding matrices based on the CSI feedback; and outputting one or more data frames using the computed precoding matrices.

Clause 76: The method of Clause 75, further comprising providing the CSI feedback for the second channel to the second wireless node.

Clause 77: The method of any one of Clauses 75-76, further comprising obtaining, from the second wireless node, CSI feedback for a third channel between a second wireless station and the first wireless node.

Clause 78: The method of any one of Clauses 75-77, further comprising:
providing the first wireless station signaling indicating a requested rank for the CSI feedback, wherein the obtained CSI feedback is of a requested rank.

Clause 79: The method of any one of Clauses 75-78, wherein: the CSI feedback for the first channel comprises a second matrix that is a diagonal real matrix, and a third matrix that is a right semi-unitary or a unitary matrix, wherein the second matrix and the third matrix are based on a singular value decomposition (SVD) of an original channel matrix for the first channel; and the CSI feedback for the second channel comprises a fifth matrix that is a diagonal real matrix, and a sixth matrix that is a right semi-unitary or a unitary matrix, wherein the fifth matrix and the sixth matrix are based on an SVD of an equivalent channel matrix for the second channel.

Clause 80: The method of Clause 79, further comprising providing the CSI feedback for the second channel to the second wireless node.

Clause 81: The method of Clause 79, wherein the equivalent channel matrix for the second channel assumes a same linear receiver associated with processing the original channel matrix for the first channel.

Clause 82: The method of any one of Clauses 75-81, wherein: the CSI feedback for the second channel comprises a first matrix that is a diagonal real matrix, and a second matrix that is a right semi-unitary or a unitary matrix, wherein the first matrix and the second matrix are based on an SVD of a channel matrix for the second channel; and the method further comprises providing the CSI feedback for the second channel to the second wireless node.

Clause 83: The method of any one of Clauses 75-82, further comprising: obtaining, from the second wireless node, CSI feedback for a third channel between a second wireless station and the first wireless node, wherein the second wireless station is associated with the second BSS.

Clause 84: The method of any one of Clauses 75-83, wherein: the CSI feedback for the first channel comprises a first matrix that is a left semi-unitary or a unitary matrix, a second matrix that is a diagonal real matrix, and a third matrix that is a right semi-unitary or a unitary matrix, wherein the first matrix, the second matrix, and the third matrix are based on a singular value decomposition (SVD) of an original channel matrix for the first channel; and the CSI feedback for the second channel comprises a fourth matrix that is a left semi-unitary or a unitary matrix, a fifth matrix that is a diagonal real matrix, and a sixth matrix that is a right semi-unitary or a unitary matrix, wherein the fourth matrix, the fifth matrix, and the sixth matrix are based on an SVD of an equivalent channel matrix for the second channel.

Clause 85: The method of Clause 84, further comprising: reconstructing the second channel based on the CSI feedback for the second channel; reconstructing the equivalent channel matrix for the reconstructed second channel wherein the equivalent channel matrix for the reconstructed second channel assumes a same linear receiver associated with processing the original channel matrix for the first channel, wherein the linear receiver is formed by one or more dominant left-singular vectors of the original channel matrix for the first channel, based on the CSI feedback for the first channel; performing an SVD of the equivalent channel matrix for the reconstructed second channel to obtain a seventh matrix that is a diagonal real matrix and an eighth matrix that is a right semi-unitary or a unitary matrix; and providing CSI feedback, based on the seventh matrix and the eighth matrix, to the second wireless node.

Clause 86: The method of any one of Clauses 75-85, wherein: the at least one packet comprises at least one null data packet (NDP); and the CSI feedback comprises at least a second matrix that comprises a diagonal real matrix, and a third matrix that comprises a right semi-unitary or unitary matrix, wherein the second matrix and the third matrix are based on an SVD of a composite channel matrix.

Clause 87: The method of Clause 86, wherein the composite channel matrix is based on: a first channel matrix for the first channel between the wireless station and the first wireless node; and a second channel matrix for the second channel between the wireless station and the second wireless node.

Clause 88: The method of Clause 86, further comprising: reconstructing the equivalent channel matrix for the second channel based on the CSI feedback; performing an SVD of the equivalent channel matrix for the reconstructed second channel to obtain a fourth matrix that is a diagonal real matrix and a fifth matrix that is a right semi-unitary or a unitary matrix; and providing CSI feedback, based on the fourth matrix and the fifth matrix, to the second wireless node.

Clause 89: The method of Clause 86, wherein the at least one NDP comprise a joint NDP output in coordination with the second wireless node, wherein the joint NDP has: one or more fields with same information from both the first and second wireless nodes; and at least one training field with a first subset of one or multiple spatial streams from the first wireless node and a second subset of one or multiple spatial streams from the second wireless node.

Clause 90: The method of Clause 89, further comprising providing information indicating the first subset and the second subset.

Clause 91: The method of Clause 90, wherein: the information is provided via a NDP announcement (NDPA) frame, or the at least one NDP.

Clause 92: The method of Clause 90, wherein the information comprises at least one of: a quantity of transmit antennas used by each of the first and second wireless nodes; or a quantity of streams from each of the first and second wireless nodes.

Clause 93: An apparatus, comprising: one or more memories comprising executable instructions; and one or more processors configured to execute the executable instructions to cause the apparatus to perform a method in accordance with any combination of Clauses 1-92.

Clause 94: An apparatus, comprising means for performing a method in accordance with any combination of Clauses 1-92.

Clause 95: A non-transitory computer-readable medium comprising executable instructions that, when executed by a processor of an apparatus, cause the apparatus to perform a method in accordance with any combination of Clauses 1-92.

Clause 96: A computer program product embodied on a computer-readable storage medium comprising code for performing a method in accordance with any combination of Clauses 1-92.

Clause 97: A wireless node (e.g., an access point), comprising: at least one transceiver; at least one memory comprising executable instructions; and at least one processor configured to execute the executable instructions to cause the wireless node to perform a method in accordance with any one of Clauses 1-13, wherein the at least one transceiver is configured to transmit the at least one packet and receive the CSI feedback.

Clause 98: A wireless node (e.g., an access point), comprising: at least one transceiver; at least one memory comprising executable instructions; and at least one processor configured to execute the executable instructions to cause the wireless node to perform a method in accordance with any one of Clauses 14-21 wherein the at least one transceiver is configured to transmit the at least one packet and receive the compressed CSI feedback.

Clause 99: A wireless node (e.g., an access point), comprising: at least one transceiver; at least one memory comprising executable instructions; and at least one processor configured to execute the executable instructions to cause the wireless node to perform a method in accordance with any one of Clauses 22-36, wherein the at least one transceiver is configured to transmit the at least one packet and receive the CSI feedback.

Clause 100: A wireless node (e.g., a wireless station), comprising: at least one transceiver; at least one memory comprising executable instructions; and at least one processor configured to execute the executable instructions to cause the wireless node to perform a method in accordance with any one of Clauses 37-51 wherein the at least one transceiver is configured to receive the one or more packets and transmit the CSI feedback.

Clause 101: A wireless node (e.g., an access point), comprising: at least one transceiver; at least one memory comprising executable instructions; and at least one processor configured to execute the executable instructions to cause the wireless node to perform a method in accordance with any one of Clauses 52-60, wherein the at least one transceiver is configured to receive the information and transmit the at least one packet.

Clause 102: A wireless node (e.g., a wireless station), comprising: at least one transceiver; at least one memory comprising executable instructions; and at least one processor configured to execute the executable instructions to cause the apparatus to perform a method in accordance with any one of Clauses 61-74, wherein the at least one transceiver is configured to receive one or more packets and transmit the CSI feedback.

Clause 103: A wireless node (e.g., an access point), comprising: at least one transceiver; at least one memory comprising executable instructions; and at least one processor configured to execute the executable instructions to cause the apparatus to perform a method in accordance with any one of Clauses 75-92 wherein the at least one transceiver is configured to transmit the one or more packets and receive the CSI feedback.

### ADDITIONAL CONSIDERATIONS

As used herein, the term “determine” or “determining” encompasses a wide variety of actions and, therefore, “determining” can include calculating, computing, processing, deriving, investigating, looking up (such as via looking up in a table, a database or another data structure), inferring, ascertaining, measuring, and the like. Also, “determining” can include receiving (such as receiving information), accessing (such as accessing data stored in memory), transmitting (such as transmitting information) and the like. Also, “determining” can include resolving, selecting, obtaining, choosing, establishing and other such similar actions.

As used herein, a phrase referring to “at least one of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b.

As used herein, “based on” is intended to be interpreted in the inclusive sense, unless otherwise explicitly indicated. For example, “based on” may be used interchangeably with “based at least in part on,” “associated with”, or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions or information.

The various illustrative components, logic, logical blocks, modules, circuits, operations and algorithm processes described in connection with the examples disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

As used herein, “a processor,” “at least one processor” or “one or more processors” generally refers to a single processor configured to perform one or multiple operations or multiple processors configured to collectively perform one or more operations. In the case of multiple processors, performance the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

In some cases, rather than actually transmitting a signal, an apparatus (e.g., a wireless node or device) may have an interface to output the signal for transmission. For example, a processor may output a signal, via a bus interface, to a radio frequency (RF) front end for transmission. Accordingly, a means for outputting may include such an interface as an alternative (or in addition) to a transmitter or transceiver. Similarly, rather than actually receiving a signal, an apparatus (e.g., a wireless node or device) may have an interface to obtain a signal from another device. For example, a processor may obtain (or receive) a signal, via a bus interface, from an RF front end for reception. Accordingly, a means for obtaining may include such an interface as an alternative (or in addition) to a receiver or transceiver.

While the present disclosure may describe certain operations as being performed by one type of wireless node, the same or similar operations may also be performed by another type of wireless node. For example, operations performed by an AP STA may also (or instead) be performed by a non-AP STA. Similarly, operations performed by a non-AP STA may also (or instead) be performed by an AP STA.

Further, while the present disclosure may describe certain types of communications between different types of wireless nodes (e.g., between an AP STA and a non-AP STA), the same or similar types of communications may occur between same types of wireless nodes (e.g., between AP STAs or between non-AP STAs, in a peer-to-peer scenario). Further, communications may occur in reverse order than described.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable sub combination. As such, although features may be described above as acting in particular combinations, and even initially claimed as such, one or more features from a claimed combination can in some cases be excised from the combination, and the claimed combination may be directed to a sub combination or variation of a sub combination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

1. An apparatus for wireless communication, comprising:
at least one memory comprising computer-executable instructions; and
one or more processors configured to execute the computer-executable instructions to cause the apparatus to:
obtain one or more packets from a first wireless node and at least one second wireless node, wherein the apparatus and the first wireless node are associated with a first basic service set (BSS) and the second wireless node is associated with a second BSS;
generate CSI feedback, based on the one or more packets, for a first channel between the apparatus and the first wireless node and for a second channel between the apparatus and the second wireless node; and
provide the CSI feedback to at least the first wireless node.

2. The apparatus of claim 1, wherein the CSI feedback is also provided directly from the apparatus to the second wireless node.

3. The apparatus of claim 1, wherein the one or more processors are further configured to cause the apparatus to:
obtain signaling indicating a requested rank for the CSI feedback, wherein the provided CSI feedback is of the requested rank.

4. The apparatus of claim 1, wherein the one or more packets comprise first and second packets obtained sequentially from the first wireless node and second wireless node.

5. The apparatus of claim 1, wherein generating the CSI feedback comprises:
performing a singular value decomposition (SVD) of an original channel matrix for the first channel to obtain a first matrix that is a left semi-unitary or a unitary matrix, a second matrix that is a diagonal real matrix, and a third matrix that is a right semi-unitary or a unitary matrix, wherein the CSI feedback for the first channel is based on the second matrix and the third matrix; and
performing an SVD of an equivalent channel matrix for the second channel to obtain a fourth matrix that is a left semi-unitary or a unitary matrix, a fifth matrix that is a diagonal real matrix, and a sixth matrix that is a right semi-unitary or a unitary matrix, wherein the CSI feedback for the second channel is based on the fifth matrix and the sixth matrix.

6. The apparatus of claim 5, wherein the equivalent channel matrix for the second channel assumes a same linear receiver associated with processing the original channel matrix for the first channel.

7. The apparatus of claim 6, wherein the linear receiver is formed by one or more dominant left-singular vectors of the original channel matrix for the first channel.

8. The apparatus of claim 1, wherein the CSI feedback comprises:
performing a singular value decomposition (SVD) of a first channel matrix for the first channel to obtain a first matrix that is a left semi-unitary or a unitary matrix, a second matrix that is a diagonal real matrix, and a third matrix that is a right semi-unitary or a unitary matrix, wherein the CSI feedback for the first channel is based on the first matrix, the second matrix, and the third matrix; and
performing an SVD of a second channel matrix for the second channel to obtain a fourth matrix that is a left semi-unitary or a unitary matrix, a fifth matrix that is a diagonal real matrix, and a sixth matrix that is a right semi-unitary or a unitary matrix, wherein the CSI feedback for the second channel is based on the fourth matrix, the fifth matrix, and the sixth matrix.

9. The apparatus of claim 1, wherein:
the one or more packets comprise one or more null data packets (NDPs) obtained from the first and second wireless nodes; and
generating the CSI feedback comprises: generating a composite channel matrix, based on the one or more NDPs, and performing a singular value decomposition (SVD) of the composite channel matrix to obtain a first matrix that is a left semi-unitary or unitary matrix, a second matrix that is a diagonal real matrix, and a third matrix that is a right semi-unitary or unitary matrix, wherein the CSI feedback is based on at least the second matrix and the third matrix.

10. The apparatus of claim 9, wherein the composite channel matrix is generated based on:
a first channel matrix for the first channel between the apparatus and the first wireless node; and
a second channel matrix for the second channel between the apparatus and the second wireless node.

11. The apparatus of claim 9, wherein the one or more NDPs comprise a joint NDP that has:
one or more fields with same information from both the first and second wireless nodes; and
at least one training field with a first subset of one or multiple spatial streams from the first wireless node and a second subset of one or multiple spatial streams from the second wireless node.

12. The apparatus of claim 11, wherein the one or more processors are further configured to cause the apparatus to:
obtain information indicating the first subset and the second subset.

13. The apparatus of claim 12, wherein the information is obtained via a NDP announcement (NDPA) frame, or the one or more NDPs.

14. The apparatus of claim 11, wherein the information comprises at least one of:
a quantity of transmit antennas associated with each of the first and second wireless nodes; or
a quantity of streams from each of the first and second wireless nodes.

15. The apparatus of claim 1, further comprising at least one transceiver configured to receive the one or more packets and transmit the CSI feedback, wherein the apparatus is configured as a wireless station.

16. An apparatus for wireless communication, comprising:
at least one memory comprising computer-executable instructions; and
one or more processors configured to execute the computer-executable instructions to cause the apparatus to:
output at least one packet to solicit channel state information (CSI) feedback from at least a first wireless station, wherein the first wireless station and the apparatus are associated with a first basic service set (BSS);
obtain CSI feedback, after outputting the at least one packet, for a first channel between the first wireless station and the apparatus and for a second channel between the first wireless station and a wireless node, wherein the wireless node is associated with a second BSS;
compute precoding matrices based on the CSI feedback; and
output one or more data frames using the computed precoding matrices.

17. The apparatus of claim 16, wherein the one or more processors are further configured to cause the apparatus to:
provide the CSI feedback for the second channel to the wireless node.

18. The apparatus of claim 16, wherein the one or more processors are further configured to cause the apparatus to:
obtain, from the wireless node, CSI feedback for a third channel between a second wireless station and the apparatus.

19. The apparatus of claim 16, further comprising at least one transceiver configured to transmit the at least one packet and receive the CSI feedback, wherein the apparatus is configured as an access point.

20. A method for wireless communications at a wireless station, comprising:
obtaining one or more packets from a first wireless node and at least one second wireless node, wherein the wireless station and the first wireless node are associated with a first basic service set (BSS) and the second wireless node is associated with a second BSS;
generating CSI feedback, based on the one or more packets, for a first channel between the wireless station and the first wireless node and for a second channel between the wireless station and the second wireless node; and
providing the CSI feedback to at least the first wireless node.
